(19) United States
(12) Patent Application Publication
(10) Pub. No.: US 2026/0172385 A1
(43) Pub. Date: Jun. 18, 2026

(54) QUANTUM CLOUD VERIFICATION

(71) Applicant: ARQIT LIMITED, London (GB)

(72) Inventors: Michael Anthony Mari, London (GB); Antony Howlett, London (GB)

(21) Appl. No.: 19/127,342

(22) PCT Filed: Dec. 7, 2023
(86) PCT No.: PCT/GB2023/053160

§ 371 Date: May 5, 2025

(30) Foreign Application Priority Data
Dec. 15, 2022 (GB) 2218986.4

(51) Int. Cl. H04L 51/52; H04L 9/40

(52) U.S. Cl. CPC H04L 51/52; H04L 63/0815; H04L 63/0838; H04L 63/0876; H04L 63/0884; H04L 63/0892; H04L 63/10; H04L 63/102

(57) ABSTRACT

Here describes a method of validating user identity on social media platforms. The method comprises receiving a set of attributes associated with a user; securing the set of attributes via the quantum-secure link connected to a quantum cloud service; storing a timestamp of the set of attributes as a record on a quantum cloud via the quantum link; providing a first verification of the user on the quantum cloud based on the set of attributes in relation to the record; selecting a social media platform registered to the quantum cloud; establishing a connection to the social media platform; retrieving user information and associated attributes from the social media platform using the connection; obtaining a secured token based on the user information and associated attributes; and providing a second verification of the user identity based on the first verification and the secured token.

The present application relates to a system, apparatus, and method(s) for validating user identity on one or more social media platforms using a quantum-secure link.

### BACKGROUND

Since their existence, online trolling and hate speeches have been huge problems for social media platforms. Public figures such as government officials, Members of the Parliament, footballers/professional athletes, celebrities in various guises, or even anyone with a modest following on/using these platforms will inevitably experience trolling and hate speech at some point, possibly even on a daily basis. They tend to have no choice but to ingest and sift through these trolling and hate speeches, which take the form of derogatory comments left by those (malicious actors) who only hide behind their anonymity.

It is known that malicious actors would maintain anonymity by creating anonymous accounts and masquerading their identities. They present themselves as someone they are not, which would affect online safety (especially for children) as these platforms become an increasing part of our daily lives. In fact, these anonymous accounts may also be used to spread misinformation, with automated bots known to have influenced such events as government elections, which cause an even greater impact on society.

Presently, many social media platforms require little verification, especially when inducting new users. For example, some platforms only require an email address to open an account due to privacy issues, and of course, simply email makes the process easier for new users. The lack of a verification process leaves these platforms venerable to exploits by malicious actors via these accounts. These platforms tend to be abused. Until a solution has been found, online trolling, hate speech, and malicious accounts will persist.

Typically, if someone says something hateful to someone's face in the streets/public, that person should be held accountable. This should not be any different for said comments made on social media platforms as we begin to rely on them more and more. It is also imperative that accounts for spreading misinformation, whether they are automated bots or real people, and malicious accounts that pretend to be someone they are not, which endangers the online safety of children, need to be dealt with urgently.

For these above reasons, it is desired a solution to address at least the above shortcomings by verifying online identity whilst maintaining a high level of privacy, yet the solution would give the user full control of what information about them is revealed, to who, and for how long.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present invention allows a user to pseudonymously share chosen attributes about themselves that have previously been verified by an external or third-party digital identity verification service (DIVS) to show a real human exists behind a social media account. QuantumCloud™ Verify is purposed to prevent online hate speech and trolling without the disadvantage of other methods.

QuantumCloud™ Verify utilizes Arqit's QuantumCloud™ encryption technology. With its multi-step verification process, QuantumCloud™ Verify identifies and filters unverified bot accounts and further prevents accounts from masquerading as someone they are not. QuantumCloud™ Verify does so by providing a way for users to show they are real humans, with complete control of what attributes via the QuantumCloud™ Verify smartphone application or website. The control is partly facilitated by certificates dynamically generated by QuantumCloud™ Verify and its users via QuantumCloud™. It is understood that these certificates could be used in many other contexts, far beyond social media platforms, including in an email signature which would solve fraudulent emails (would require generating a certificate link for an email account and proving you are the owner of the email account you are verifying).

More specifically, QuantumCloud™ Verify acts as an effective middleman between a DIVS which provides digital identify verification, and social media platforms. QuantumCloud™ Verify provides the user a way to verify that they are a real person whilst keeping their identity hidden from social media platforms. User is allowed to maintain control over there sensitive data and maintain the verified identity. The users are equipped with their own quantum-safe encryption key (or user key described herein) which they can revoke at any time, giving them full control over their verified digital identity.

On the one hand, QuantumCloud™ Verify provides verification via a REST endpoint for social media platforms to call to request the verification status of a user. All cryptographic keys are generated by QuantumCloud™ which results in all encryptions for both data-in-transit and data-at-rest being quantum-safe. On the other hand, QuantumCloud™ Verify offers a way to dynamically generate an HTML-certificate showing the attributes a user wishes to share for a particular platform, accessible by providing a short-URL as a way of a separate verification.

In a first aspect, the present disclosure provides a computer-implemented method of using a quantum-secure link to validate user identity on one or more social media platforms, the method comprising: receiving a set of attributes associated with a user, wherein said one or more attributes are provided using a digital identity verification service; securing the set of attributes via the quantum-secure link connected to a quantum cloud service or QuantumCloud™; storing a timestamp of the set of attributes as a record on the quantum cloud via the quantum link; providing a first verification of the user on the quantum cloud based on the set of attributes in relation to the record; selecting a social media platform registered to the quantum cloud; establishing a connection to the social media platform; retrieving user information and associated attributes from the social media platform using the connection; obtaining a secured token based on the user information and associated attributes; and providing a second verification of the user identity based on the first verification and the secured token, wherein the second verification is dependent on the first verification.

In a second aspect, the present disclosure provides a digital identity verification system, the system comprising: at least one cloud server, a database situated on said least one cloud server secured via a quantum-secure link to one or more external user devices, wherein said least one cloud server is adapted to sync input from a user device with one or more social media platforms, wherein said at least one cloud server comprises one or more modules configured to: receive a set of attributes associated with a user using the user device, wherein said one or more attributes are provided using a digital identity verification service; secure the set of attributes via the quantum-secure link connected to a database configured to store a timestamp of the set of attributes as a record on said at least one cloud server; provide a first verification of the user identity on said at least one cloud server based on the set of attributes in relation to the record; select a social media platform from said one or more social media platforms via the user device; confirm whether the social media platform has been registered to said least one cloud server; connect to the social media platform; retrieve user information and associated attributes from the social media platform; obtain a secured token based on the user information and associated attributes; provide a second verification of the user based on the first verification and the secured token; and syncing the input from the user devices with one or more social media platforms based on the first verification and second verification.

In a third aspect. the present disclosure provides an apparatus comprising a processor, a memory and a communication interface, the processor connected to the memory and communication interface, wherein the apparatus is adapted or configured to implement the method according to the first aspect.

The methods described herein may be performed by software in machine-readable form on a tangible storage medium e.g. in the form of a computer program comprising computer program code means adapted to perform all the steps of any of the methods described herein when the program is run on a computer and where the computer program may be embodied on a computer-readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The optional features or options described herein may be combined as appropriate, as would be apparent to a skilled person, and may be combined with any of the aspects or embodiments of the invention.

### BRIEF DESCRIPTION OF THE DRAWINGS

Embodiments of the invention will be described, by way of example, with reference to the following drawings, in which:

FIG. 1 is a flow diagram illustrating an example process of QuantumCloud™ Verify, using a quantum-secure link to validate user identity on one or more social media platforms according to the invention;

FIG. 2 is a schematic diagram illustrating an example of QuantumCloud™ Verify as part of a digital identity verification system according to the invention;

FIG. 3 is a sequence diagram illustrating an example of a user using QuantumCloud™ Verify according to the invention;

FIG. 4 is a sequence diagram illustrating an example of linking a social media account using QuantumCloud™ Verify smartphone application according to the invention;

FIG. 5 is a sequence diagram illustrating an example of linking a social media account from the social media platforms settings according to the invention;

FIG. 6 is a sequence diagram illustrating another example of generating a certificate to show verified attributes for social media platforms according to the invention;

FIG. 7 is a sequence diagram illustrating an example of verifying a social media account is a verified user according to the invention;

FIG. 8 is a sequence diagram illustrating an example of Verifying a public-facing QuantumCloud™ Verify certificate via a URL according to the invention;

FIG. 9A is a sequence diagram illustrating an example of an end-to-end workflow of QuantumCloud™ starting from a user according to the invention;

FIG. 9B is a sequence diagram illustrating an example of an end-to-end workflow of QuantumCloud™ without cloud application proxy according to the invention;

FIG. 10 is a sequence diagram illustrating an example of an onboarding process with QuantumCloud™ Verify according to the invention;

FIG. 11 is a sequence diagram illustrating an example of linking QuantumCloud™ Verify with a social media platform according to the invention;

FIG. 12 is a sequence diagram illustrating an example of generating a quantum-secure link between the DIVS and QuantumCloud™ Verify according to the invention;

FIG. 13 is a sequence diagram illustrating an example of generating a quantum-secure link between QuantumCloud™ Verify cloud application and QuantumCloud™ Verify smartphone application according to the invention; and

FIG. 14 is a block diagram of a computer or computing device suitable for implementing embodiments of the invention.

Common reference numerals are used throughout the figures to indicate similar features.

### DETAILED DESCRIPTION

Embodiments of the present invention are described below by way of example only. These examples represent the suitable modes of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Present invention is related to the implementation and utilization of QuantumCloud™ Verify. The QuantumCloud™ Verify provides verified identities for the users of social media platforms registered to QuantumCloud™ Verify through QuantumCloud™ (or quantum cloud service) that allows for symmetric key agreement without key exchange. In turn, the QuantumCloud™ Verify (or quantum cloud or server(s) thereof) enables the users of these platforms to take control of what verified information they want to share with the social media platform independent of the social media platform settings.

QuantumCloud™ Verify is thus purposed to maintain user privacy whilst providing a new verification solution and to give everyone on social media the option to view comments only from verified accounts. (Requires full integration from social media platforms). To this end, QuantumCloud™ Verify would effectively prevent malicious accounts for online safety, especially for children, and to reduce bot accounts that can influence things such as elections and spread misinformation.

QuantumCloud™ Verify is adapted to allow a user to pseudonymously share chosen attributes about themselves that have previously been verified by a DIVS, to show a real human exists behind a social media account, as above-mentioned. This is achieved by securely storing the token returned from a DIVS, which is both encrypted and signed using quantum-safe symmetric keys as described herein. QuantumCloud™ Verify indeed facilitates the prevention of online hate speech and trolling by allowing social media companies to call a REST endpoint on QuantumCloud™ Verify to obtain the verification status of a user on their platform. QuantumCloud™ Verify can verify the user both with and without integration from the social media platforms.

With requisite integration from social media platforms, accounts that are not verified could be removed from users'feeds. This is achieved by the social media platform requesting the verified status of a user of their platform and providing a filtering mechanism simply based on verification status as herein described.

Without integration from social media platforms, using the dynamically generated certificate provides a way for users to still show they are real humans, with complete control of what attributes are shown in the certificate that is dynamically generated, as herein described.

QuantumCloud™ Verify also functions to help identify bot accounts that will not be able to have a verified digital identity and therefore cannot be verified using QuantumCloud™ Verify. This results in the social media account not being verified, allowing it to be filtered out from a user's feed, or if a user chooses to still see content from anonymous accounts, they will know due to the account not being verified that the information could be questionable, as herein described.

Moreover, QuantumCloud™ Verify may prevent accounts from masquerading as someone they are not, which is imperative to online child safety. Similar to the above, if a social media account does not have verified status, then the authenticity of that account can be instantly brought into question, as herein described.

QuantumCloud™ Verify generates certificate(s) that could be used in many contexts far beyond social media platforms, including in an email signature which would solve fraudulent emails (would require generating a certificate link for an email account and proving you are the owner of the email account you are verifying). Starting with the QuantumCloud™ Verify smartphone application, the user may select which attributes to show and how to generate a certificate link the user can share. Then QuantumCloud™ Verify will dynamically generate this certificate when another user clicks the link.

Herein described QuantumCloud™ Verify comprises a cloud application that provides the link between digitally verified identity information and a user account on a social media platform, underpinned by quantum-secure encryption powered by QuantumCloud™, where QuantumCloud™ is understood to be a system that securely brokers symmetric keys between two separate devices, allowing for a quantum-secure connection between them. The quantum-secure connection may comprise or be a quantum-secure link.

QuantumCloud™ Verify via the quantum-secure link acquires the ability to direct a social media platform to query a registered username to see if verified information is associated with that account. This provides a pseudonymous solution presented herein, offering sufficient user privacy, revealing (only) that a verified human/person holds the account. In other words, the user is only required to reveal that they are a verified person, and no more, or otherwise they could choose to reveal specific attributes about themselves tailored for the social media platform.

QuantumCloud™ Verify provides a computer-implemented method for (of) linking verified user attributes using, for example, a third-party digital identity verification service (herein referred to as DIVS), to then allow a user to selectively choose which attributes are visible to which social media platforms. The linking process may be accomplished with a connection using a quantum-secure link. The connection validates user identity with respect to one or more social media platforms and allows the passing of information in a more secure manner. The connection using the QuantumCloud™ may also be referred to as or correspond to the quantum-secure link, where the quantum-secure link establishes a secure link between two or more devices via a shared-symmetric key (referred herein as P2P key) brokered by the QuantumCloud™.

QuantumCloud™ Verify, where the QuantumCloud™ is purposed to receive a set of attributes associated with a user of the platform, where the attributes are provided using the DIVS. The set of attributes via the quantum-secure link connected to the QuantumCloud™ is secured and stored on the DIVS. To establish the connection with the social media platform, the user will proceed with a first verification based on the set of attributes. A social media platform registered to the QuantumCloud™ Verify through QuantumCloud™ is selected following the first verification, and the secured connection is thereby established. User information and associated attributes from the social media platform can be transmitted via the connection. A secured token based on the user information and associated attributes is obtained upon the transmission of the user information and associated attributes. The QuantumCloud™ Verify proceeds with the verification process by providing a second verification of the user identity based on the first verification and the secured token. The user identity may be validated based on the first verification and the second verification being successful, and one or more certificates may be dynamically generated in accordance with the validation and based on user instructions. This permits QuantumCloud™ Verify to control user settings with respect to said one or more social media platforms once the user is validated and based on user instructions.

When used with various social medial platforms, for example, Facebook, a user of Facebook may choose (by setting permissions) to reveal that he/she is male, from the UK, and between the ages of 35-45. For Instagram, the user may choose to reveal that he/she is a verified user. Setting these permissions of who has access to what verified attribute would be functionality provided by QuantumCloud™ Verify.

Moreover, while some users may not wish to verify their identity with their social media profile, this technology would act as an enabler for social media platforms to develop additional layers of filtering on social media comments. For example, a user may eventually be able to choose to allow only comments from verified users, essentially providing a layer of accountability to comments that are posted on that user's content.

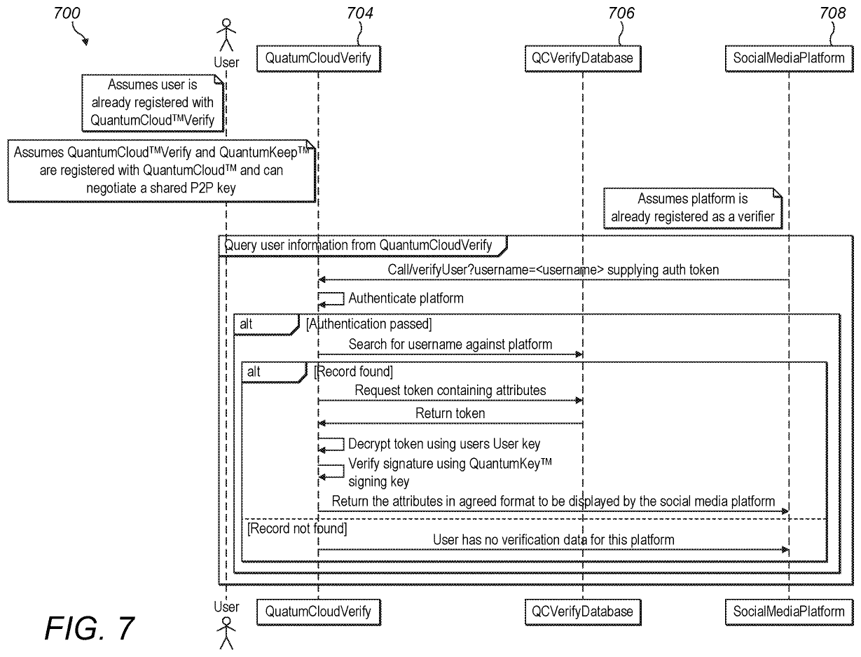

Furthermore, QuantumCloud™ Verify may also integrate with a digital identity verification platform (with DIVS) in order to provide verified attributes, which can then be associated with any social media platform. Social media platforms would be able to integrate with QuantumCloud™ Verify by simply providing a URL endpoint that QuantumCloud™ Verify could call to verify a user on their platform. For example, a REST or RESTful endpoint may be provided by QuantumCloud™ Verify such that social media platforms will integrate with it. By calling this endpoint, social media platforms will be able to determine if a user on their platform is verified. This is further illustrated according to FIG. 7 and described herein.

Although this document primarily focuses on social media platforms, the capability proposed can very easily be expanded to other areas and platforms such as job sites like LinkedIn and Glassdoor, dating websites, review sites such as Amazon, Trustpilot, TripAdvisor, and other platforms that permit user accounts.

The QuantumCloud™ Verify may be implemented on a digital identity verification system. The system may comprise a cloud server, a database situated on said least one cloud server secured via a quantum-secure link to one or more external user devices, where the cloud server is adapted to sync input from a user device with one or more social media platforms via the quantum-secure link.

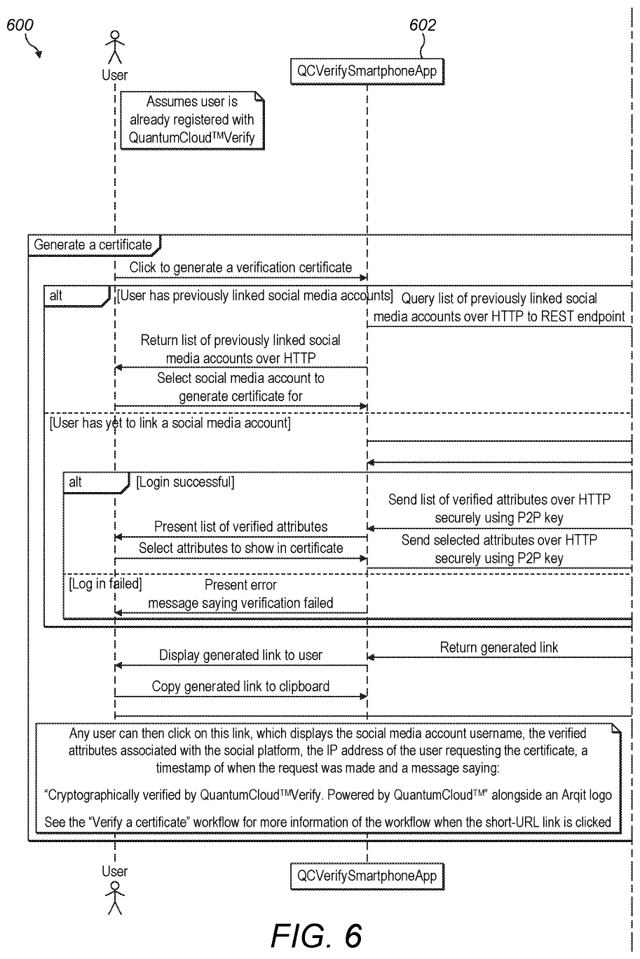

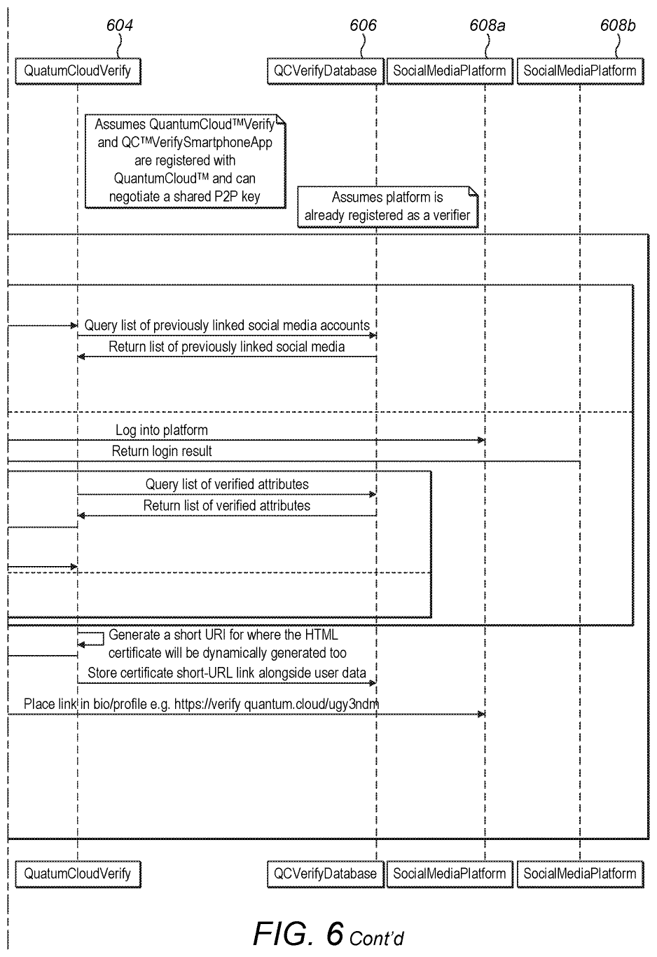

For example, the system may comprise a web service with a REST interface, QuantumCloud™ Verify, situated on the cloud server, which provides all the logic required to pseudonymously and securely provide a link to previously verified attributes verified by a DIVS and a social media platform; a database to allow for fast lookups of username to verified attributes, and store a short-URL link to allow for dynamically generated certificates showing username, associated verified attributes, the IP address of who clicked the link along with a timestamp; and smartphone application that allows the user to go through the verification process, and selectively choose verified attributes for use within various social media platforms. The generation of the certificates is illustrated according to FIG. 6 and described herein. This will also provide the ability to generate a short-URL for a dynamically generated certificate per platform, for the user to place into their profile/bio for other users to click and see verified information linked to that social media account.

Further, the cloud server implemented in conjunction or together with (quantum secured) QuantumCloud™ Verify may comprise one or more modules that are configured to: receive a set of attributes associated with a user using the user device, wherein said one or more attributes are provided using a digital identity verification service; secure the set of attributes via the quantum-secure link connected to a database configured to store a record of the set of attributes and a timestamp of the record on said at least one cloud server; provide a first verification of the user identity on said at least one cloud server based on the set of attributes; select a social media platform from said one or more social media platforms via the user device; confirm whether the social media platform has been registered to said least one cloud server; connect to the social media platform; retrieve user information and associated attributes from the social media platform; obtain a secured token based on the user information and associated attributes; provide a second verification of the user based on the first verification and the secured token; and sync the input from the user devices with one or more social media platforms based on at least the second verification.

The first and second verification forms the basis for validating the user identity to the extent that said one or more modules of QuantumCloud™ Verify may also be configured to perform any of the methods described herein, allowing each user using the social media platform via QuantumCloud™ Verify (and in relation to the dynamically generated certificates) to selectively choose which attributes are visible to which social media platforms accomplished by performing at least the following steps 1.1 to 1.4.

### 1.1 Verify a User Using a Third-Party DIVS

When a user signs up to QuantumCloud™ Verify, the first thing they will need to do is verify themselves. QuantumCloud™ Verify will act as a proxy between the DIVS and the user, and request they upload a photo ID document, followed by a liveness check such as taking a selfie or blinking into the camera to prove they are the person in the photo ID document. Data exchange from the QuantumCloud™ Verify smartphone application, to QuantumCloud™ Verify cloud application and to the DIVS will all be done via a quantum-secure link provided by QuantumCloud™. The DIVS will be required to integrate with QuantumCloud™. QuantumCloud™ Verify will then store a record of the attributes extracted from this verification process against the QuantumCloud™ Verify user in the cloud application, which will be selectable when linking to a social media account.

### 1.2 Linking a Social Media Account Using the QuantumCloud™ Verify App

Once a user is verified within QuantumCloud™ Verify, they will be presented with the option to link a social media account to their profile. Through an onboarding process, social media platforms will register as a verifier with QuantumCloud™ Verify. A list of social media platforms will be displayed to the user from within the QuantumCloud™ Verify smartphone application, which they will then log into to prove they own the account. At this point, the user will select which verified attributes to share for this particular platform. QuantumCloud™ Verify would provide additional options for how the attribute is displayed, allowing the user to cherry-pick how certain attributes are shared. They can choose to shorten them, or make them as vague as they wish such as simply displaying, they are from the UK rather than their full address, or an age range rather than their actual age. At this point a token will be generated and signed using a signing key only known to QuantumCloud™ Verify. This token will then be encrypted using the User key from QuantumCloud™ Verify and stored persistently alongside the user's other data in the cloud application. This signed and encrypted token is then retrieved and then decrypted, and the signature is verified to reveal the users verified attributes when it comes to displaying them in either the social media platform or the generated certificate (see point 1.4 below and FIG. 7)

### 1.3 Linking a Social Media Account From the Social Media Platform Settings

With full integration from social media platforms, a user would log into their social media account, go to settings and click “Verify account”. This would call out to QuantumCloud™ Verify cloud application passing an HTTP request to a REST endpoint, which would trigger a push notification to the user QuantumCloud™ Verify smartphone application, and the same process would be followed in section 1.2 from the point of the user selecting which attributes to share.

### 1.4 Verifying a Social Media Account Is a Verified User

There are two possible ways for a user to prove they are verified: 1) Integration from asocial media platform to prove an account is verified; and 2) Generating a certificate to show verified attributes for a social media platform.

Under 1) QuantumCloud™ Verify cloud application will provide a single endpoint for social media platforms to call to check the verification status of a user. This endpoint will take the username of the user and require the social media platform to provide an authentication token in the request. This authentication token is granted to the social media platform during onboarding. QuantumCloud™ Verify cloud application will perform a look-up to see if a record exists for this username against the social media platform making the request. If a record exists, it will retrieve the encrypted token, decrypt it using the User's key and then verify the signature using the signing key. The verified attributes will be returned to the social media platform via QuantumCloud™ Verify for them to display as they choose. These attributes have been pre-selected by the user against this social media platform (See section 1.2).

Under 2) to remove the reliance on the integration required from social media platforms, QuantumCloud™ Verify will provide the ability to dynamically generate a certificate-like HTML page (or fragment for embedding in another page) displaying a user's social media account username, the verified attributes they have chosen to share, the IP address of the user who clicked the link, the timestamp of when it was clicked and a message saying: “Cryptographically verified by QuantumCloud™ Verify. Powered by QuantumCloud™”. This certificate would be generated dynamically and presented as an HTML page (or fragment) and can be viewed by anyone in any browser

Quantum-secure(d) link herein refers to using herein described digital identity verification system (registered with QuantumCloud™) to broker a shared-symmetric key (also referred to as a peer-to-peer key) to allow two devices to have a quantum connection or connection secured between two or more components of the system. It is understood that quantum-secure link comprises quantum secure session keys that are generated using one or more algorithms provided for elsewhere and is neither part of nor within the scope of this application. An example implementation of a quantum-secure link can be found in or with reference to applications GB2100434.6 and EP2100434.6.

It is also understood that secure session keys may be generated and established between two or more devices as a quantum-secure link. Both devices are under a network that comprises a first key node and a second key node, the first key node and second key node with access to the same set of keys. The first device may receive data representative of first key establishment data from at least the first key node and the second device for use in calculating, for example, a bilocation Key, where the bilocation key is based on a selected key from the set of keys. The second device may receive data representative of second key establishment data from at least the first device for use in requesting the bilocation Key from the second key node, where the Bilocation Key is calculated based on the selected key from the set of keys. The first and second devices may use their corresponding bilocation keys to each generate a final key based on an agreed portion of the first key establishment data and second key establishment data. As such, the quantum-secure link between the two devices is established.

Social media platform herein refers to any cloud platform, which allows users to build their social network. Examples of social network platforms are provided through the application.

Set of attributes and attributes associated with a user herein refers to a container or features for information related to the user, such as age, race, likes, and etc. The set of attributes may be present as a list or a set. The attributes may be numerical or categorical in form and provided exclusively by the DIVS. A registered set of attributes or attributes are attributes that pass the verification process. They are deemed registered with the QuantumCloud™ Verify for a particular user.

QuantumCloud™ Verify, herein known as quantum cloud, refers to the technology which securely brokers symmetric keys between two separate devices, allowing for a quantum-secure connection between them. The quantum cloud may be situated on one or more servers and comprise one or more modules configured to execute herein described step(s).

QuantumCloud™, herein known as quantum cloud service, refers to a platform as a service (PaaS) that allows for and enables symmetric key agreement without key exchange, so generating symmetric encryption keys in two locations that are quantum-safe. QuantumCloud™ thereby provides Quantum Cloud™ Verify with the capability to establish quantum-safe secure communications.

The first verification of QuantumCloud™ Verify may be facilitated by the use of a third-party cloud service provider, Digital Identity Verification Service or DIVS, which delivers online identity verification via a combination of biometric scanning and identity document upload. It is understood and assumed that the DIVS must be integrated with QuantumCloud™ to provide a quantum-secure connection with QuantumCloud™ Verify.

A secured token herein refers to a peripheral device/item used to gain access to an electronically restricted resource. Here, a secured token will be generated and signed using a signing key only known to QuantumCloud™ Verify. This token will then be encrypted using the User key from QuantumCloud™ Verify and stored persistently alongside the user's other data in the cloud application.

The signed and encrypted token is then retrieved and then decrypted, and the signature is verified to reveal the users'verified attributes when it comes to displaying them in either the social media platform or the generated certificate used in the second verification and validation.

Signing key herein refers to a quantum-secure symmetric key generated by via QuantumCloud™ and only known only to QuantumCloud™ Verify. Used to sign tokens.

User key herein refers to a quantum-secure symmetric key generated by QuantumCloud™ Verify on behalf of the user. Used to encrypt all user's data.

QuantumCloud™ Verify Smartphone application herein refers to Aa smartphone application that has or will have a quantum-secure connection to QuantumCloud™ Verify.

Cloud application, QuantumCloud™, refers to a web service and associated database which reside on one or more cloud servers.

Based on the above, the following figures provide the example(s) of a digital identity verification system and the underlying methods and steps for performing validation for users of the social media platforms.

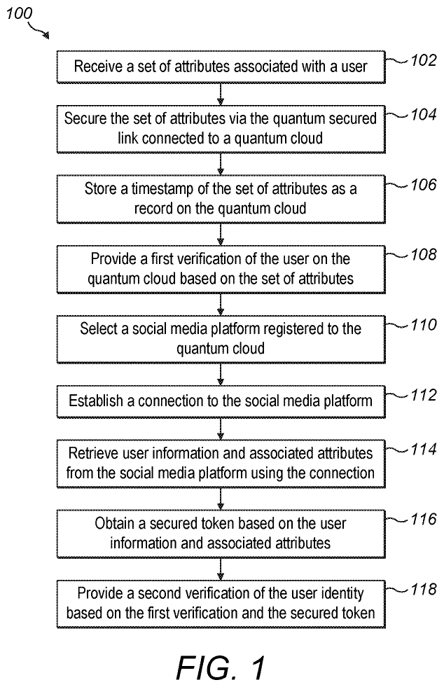

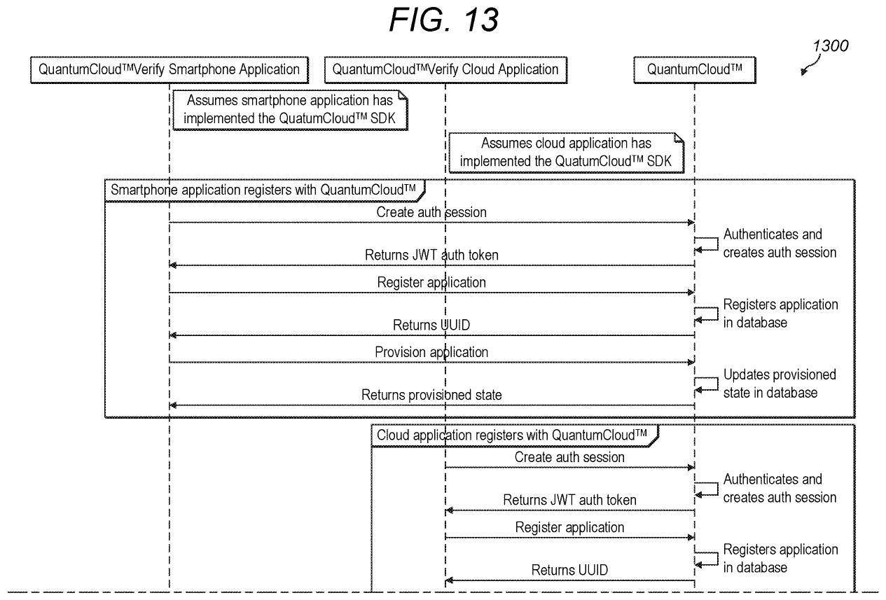

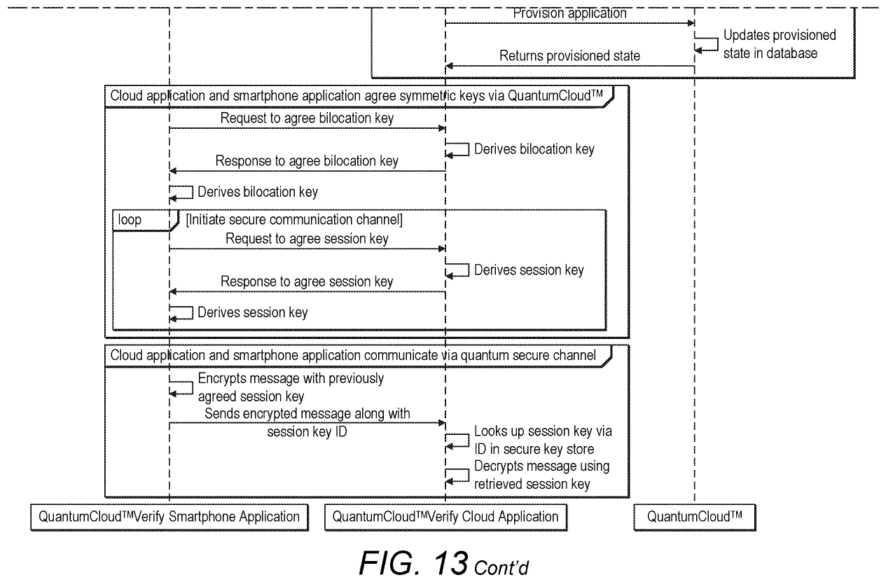

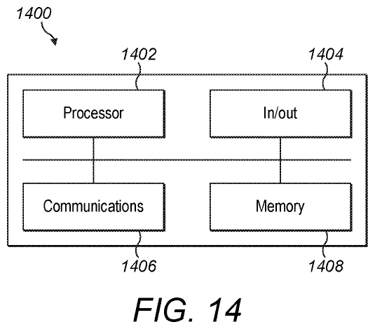

FIG. 1 is a flow diagram 100 illustrating an example process using a quantum-secure link provided by QuantumCloud™ Verify. The quantum-secure link is used to validate user identity on one or more social media platforms. The quantum-secure link is formed between various components of the digital identity verification system, as described in FIGS. 13 and 14. For example, the quantum-secure link may be used to secure a connection between the cloud server and the user interface. When deployed, QuantumCloud™ Verify is used to validate the user's identity. QuantumCloud™ Verify comprises one or more cloud servers that are configured to execute at least the following steps.

In step 102, the QuantumCloud™ receives a set of attributes associated with a user of a social media platform. Each attribute received is provided with a DIVS (external to or as part of the overall system) to which verifies the user of his/her identity. This verification can be achieved if the user is registered already with QuantumCloud™ Verify. For example, registration can be accomplished by downloading the QuantumCloud™ Verify Smartphone application and creating an account. Concurrently, QuantumCloud™ Verify Smartphone application, QuantumCloud™ Verify Cloud application, and DIVS are registered with QuantumCloud™ allowing a quantum-secure connection.

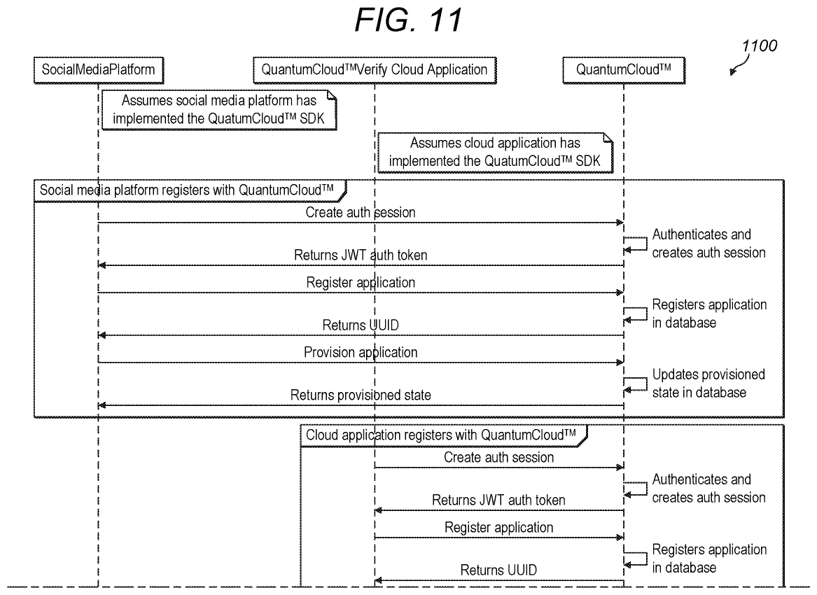

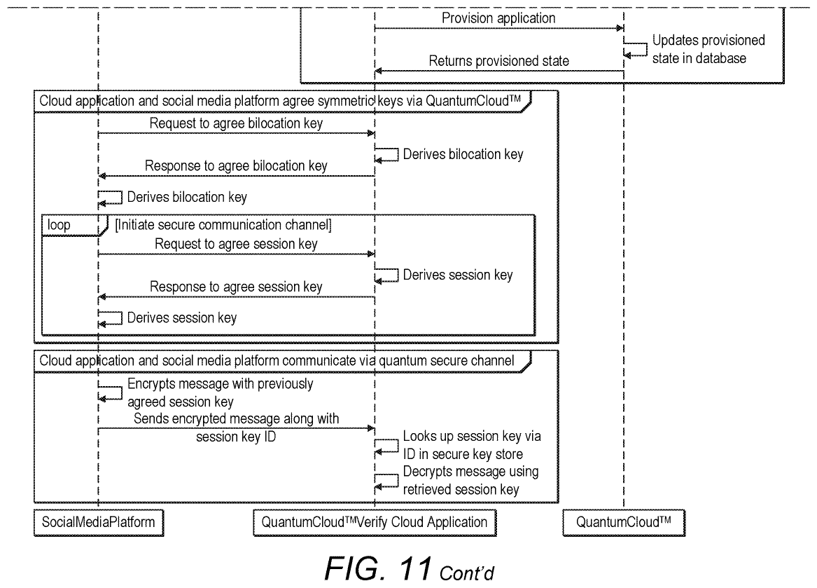

In step 104, the set of attributes is secured via the quantum-secure link that is created via QuantumCloud™. The quantum-secure link connects the various components of QuantumCloud™ Verify, for example, the QuantumCloud™ Verify smartphone application, as shown in FIGS. 11 to 13.

In step 106, a timestamp associated with the set of attributes is stored as a record via the quantum link secured using QuantumCloud™ Verify via QuantumCloud™ in the process. The data underlying or associated with these attributes remain situated on the DIVS. QuantumCloud™ Verify does not require storing them but only a record of data during the first verification.

In step 108, a first verification of the user on QuantumCloud™ Verify is provided based on the set of attributes or a record thereof, optionally including the timestamp associated. The first verification may be accomplished by one or more successfully recorded timestamps or via other means using the timestamps. For example, once the DIVS sends back the verification result to QuantumCloud™ Verify cloud application. If the result was successful, a record is added with a timestamp the verification took place and is persistently stored against the QuantumCloud™ Verify user, and a notification is sent back to inform the user verification was successful. If verification fails, no record is stored against the QuantumCloud™ Verify user and a notification is sent back to inform the user verification failed.

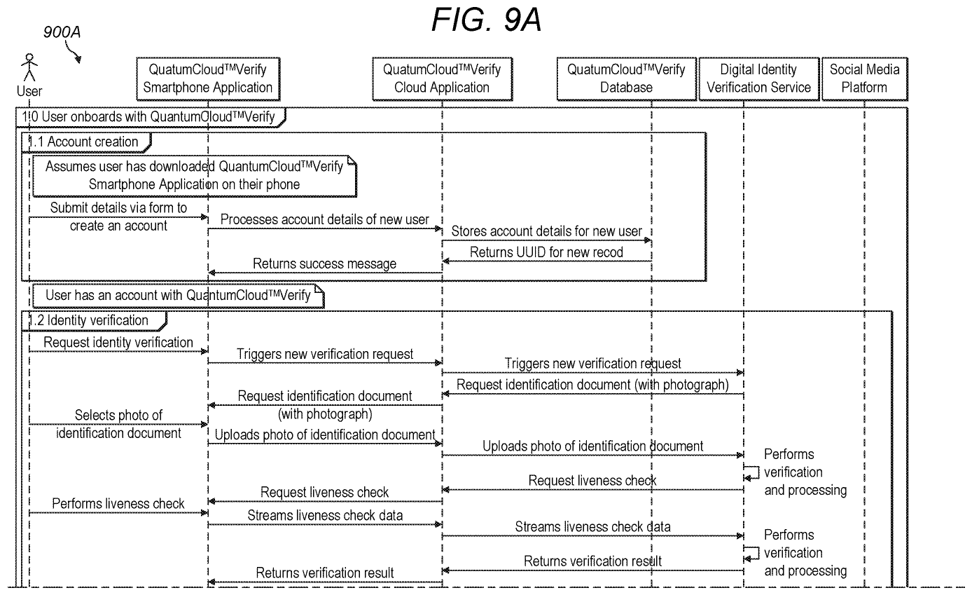

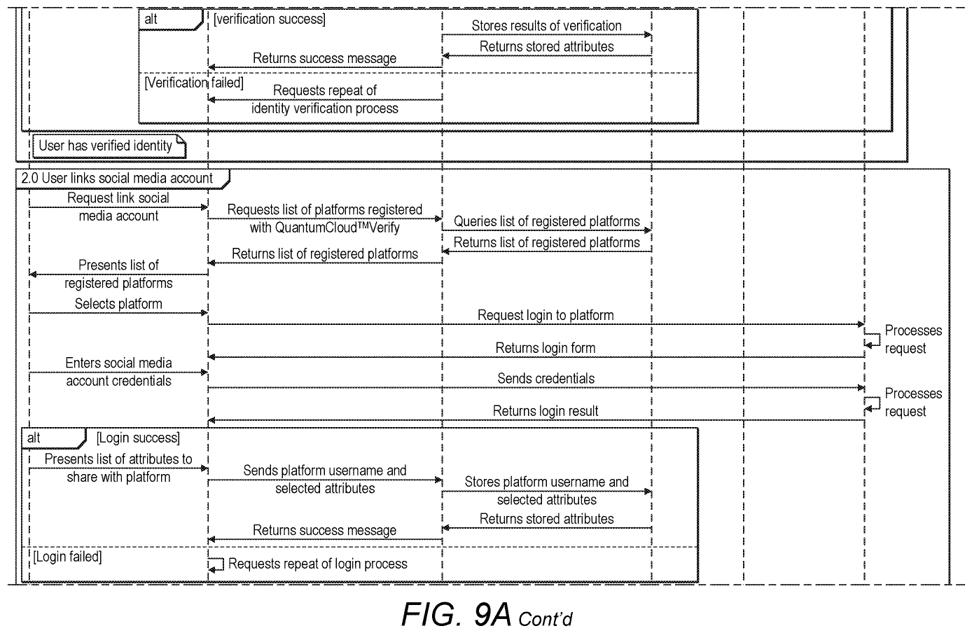

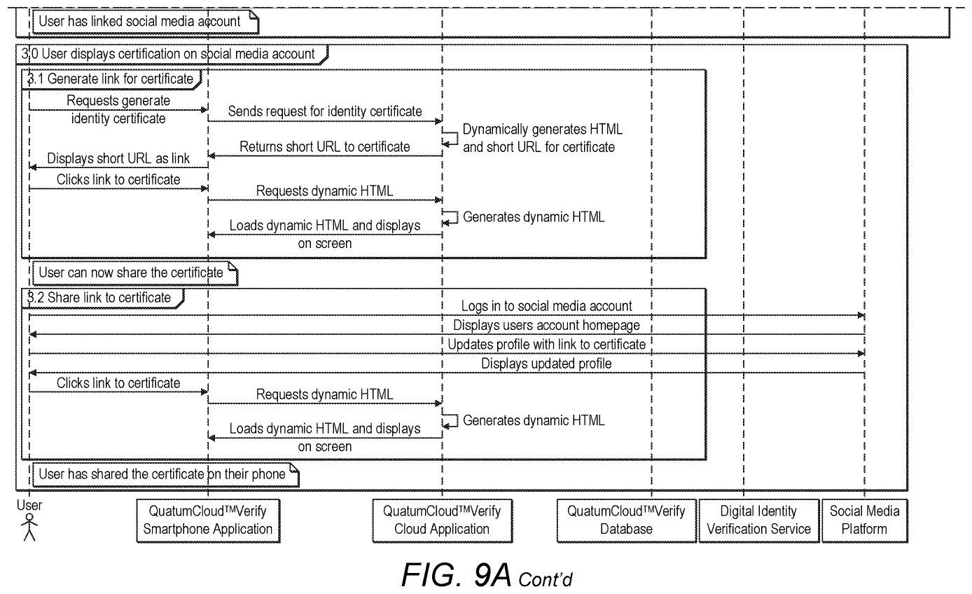

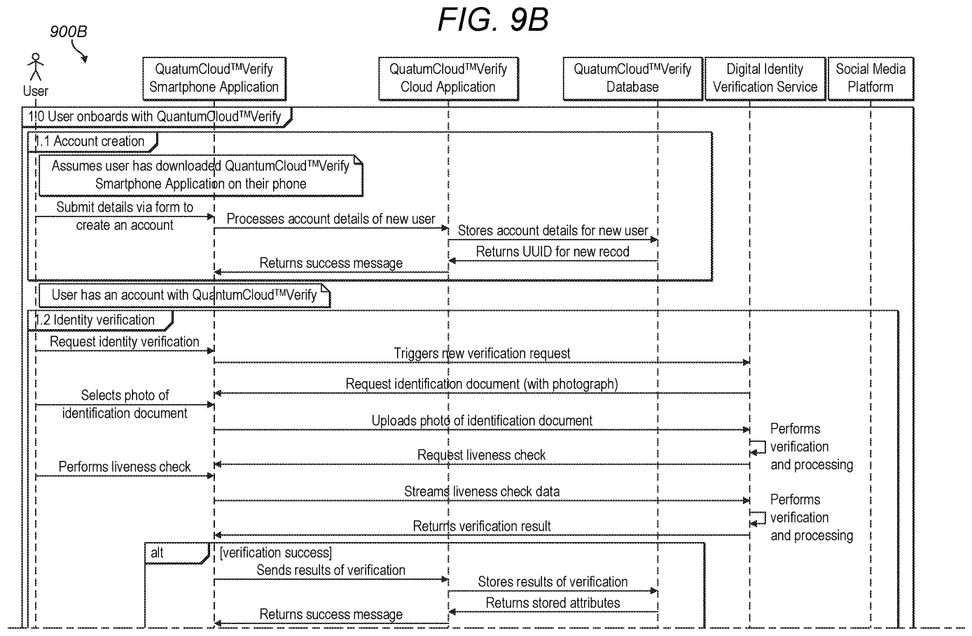

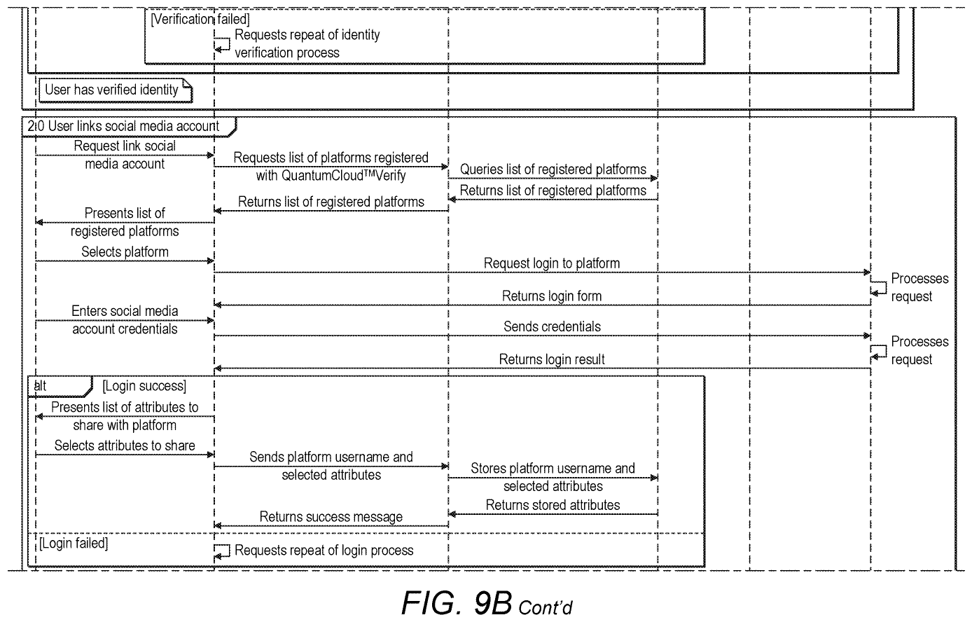

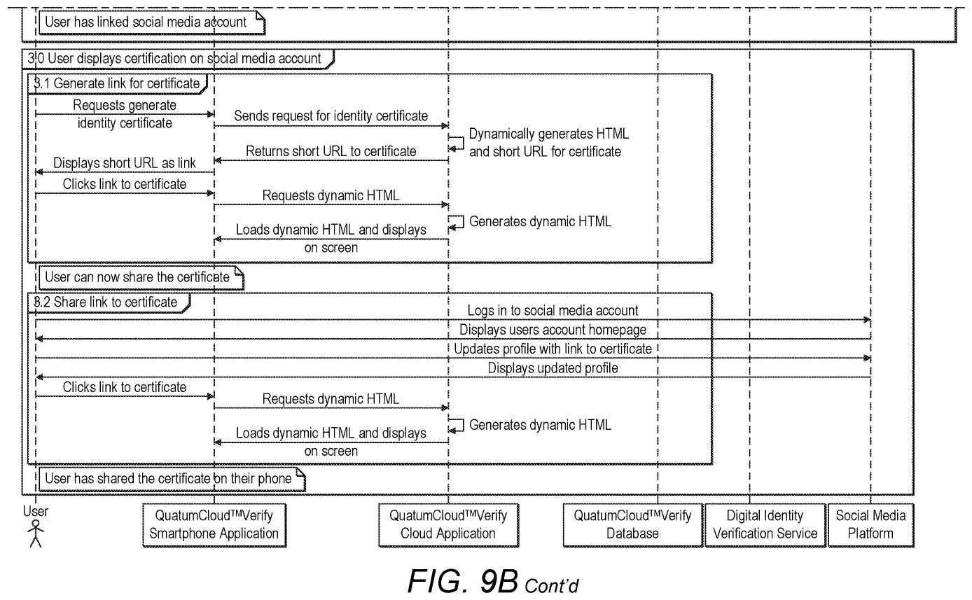

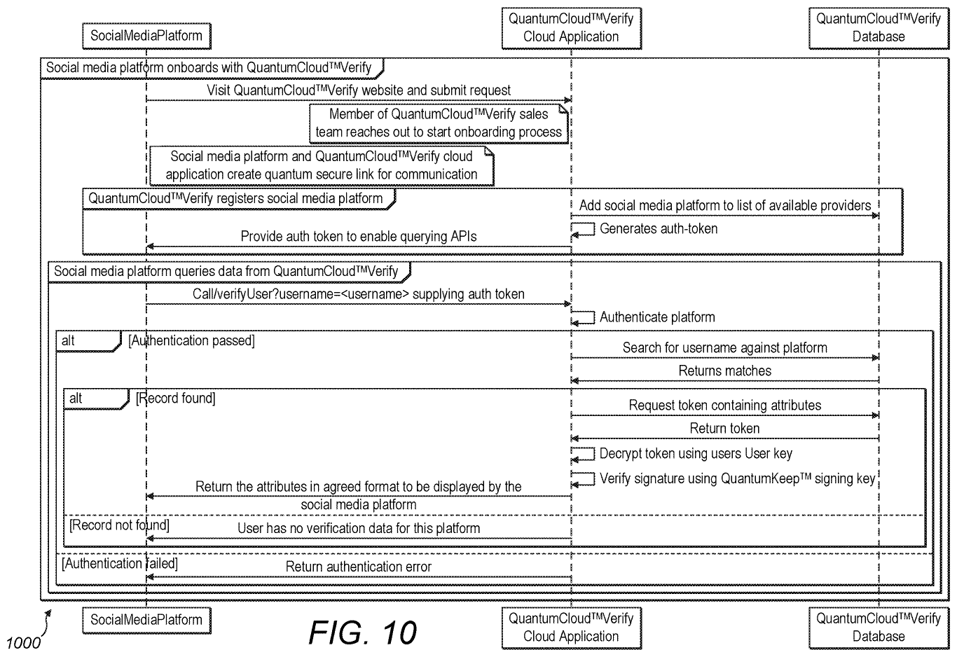

In practice, following the first verification or while the first verification is taking place, an authentication token may be requested from the social media platform by QuantumCloud™ Verify. The authentication token may comprise at least one user identifier associated with a user account on the social media platform. QuantumCloud™ Verify determines whether the social media platform is registered based on the authentication token as part of the onboarding process, as illustrated in FIGS. 9A, 9B, and 10.

In step 110, QuantumCloud™ Verify selects a social media platform registered to the QuantumCloud™. The registered social media platform has gone through the onboarding process and acknowledged by QuantumCloud™ Verify using QuantumCloud™.

In step 112, a connection to the social media platform may be established. The connection may be associated with the quantum-secure link for securing the set of attributes. The quantum-secure link provides a connection between the various components of QuantumCloud™ Verify.

In step 114, user information and associated attributes may be retrieved from the social media platform using the connection established through the quantum-secure link.

In step 116, a secured token is obtained based on the user information and associated attributes. For example, the secured token may be generated and obtained by receiving a user identifier associated with a user account on the social media platform; generating the token based on the user identifier comprising the user information and associated attributes; signing the token using a signing key; and encrypting the token using a user key; and providing the secured token encrypted for the second verification in the following step.

In step 118, a second verification of the user identity is provided based on the first verification and the secured token. The second verification ensures that the verification can be triggered from the settings of the social media platform.

In practice, QuantumCloud™ Verify determines whether the social media platform is registered based on the authentication token requested previously. For example, QuantumCloud™ Verify conducts a search for the user account on the social media platform in accordance with the registration, based on said at least one user identifier associated with a user account.

The secured token described herein may comprise the user information and/or associated attributes. The token may be obtained based on the search. The secured token is used for second verification such that each social media platform is verified with a connection secured to QuantumCloud™ Verify using the token. The secured token may be stored by QuantumCloud™ Verify in relation to the user information and associated attributes for easy look-up.

When using the secured token for the second verification, the secured token may be decrypted using a user key. The underlying user information may be verified using a signing key. A subset of attributes corresponding to the user information and the associated attributes can be identified in the process. As an option, a subset of attributes from the set of attributes would be transferred to the social media platform. The set of attributes would be stored by QuantumCloud™ Verify in relation to the secured token for ease of recall. This process enables updating the subset of attributes on the social media platform in a selective and secure manner.

When QuantumCloud™ Verify is deployed, the user account (including information and associated attributes) can be updated via the connection established by the quantum-secure link. To do so, the user of/on the social media platform may select from a list of verified social media platforms registered with QuantumCloud™ Verify. On the selected social media platform, a user account may be identified based on user information. Based on the second verification, a secured connection to the user account is provided, linking the user to the selected social media platform. One or more attributes associated with the user account may be transmitted from the set of attributes to the social media platform via the secured connection. The user account can be updated based on said one or more attributes transmitted, assuming the second verification is successful.

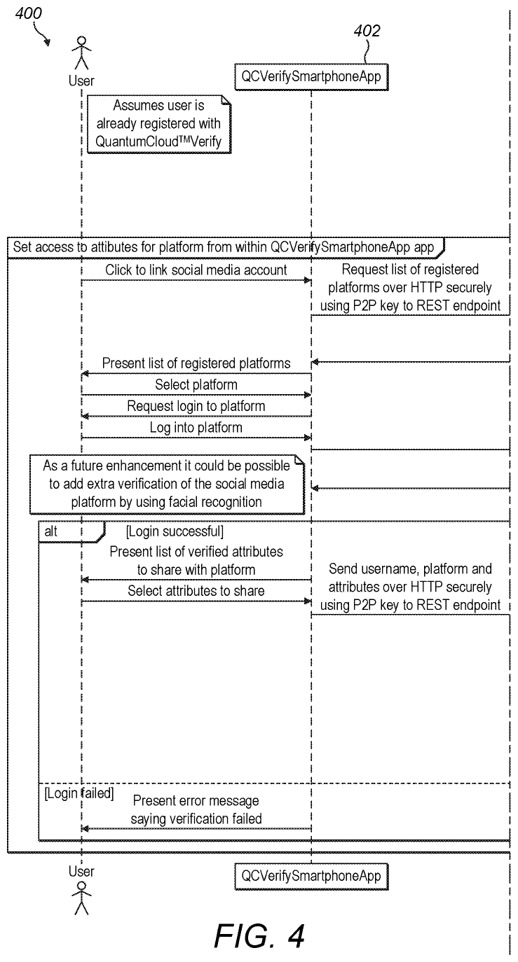

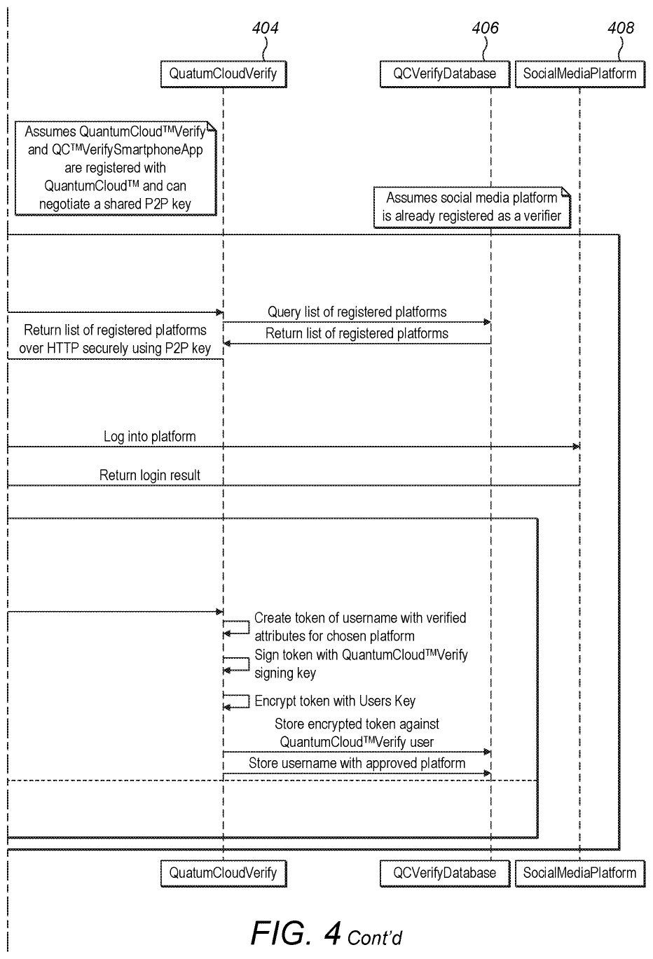

In particular, once QuantumCloud™ Verify determines the user is verified, the cloud application may notify the social media platform (with integration) via a REST endpoint that the user is now verified. Provide the verification, QuantumCloud™ Verify also controls how the information may be displayed via certificate(s) that is dynamically generated as described herein and illustrated in FIGS. 4 to 6 and 9A, 9B. The certificate may be generated via a short-URL (without platform integration) that can be placed anywhere, and what attributes they would like the certificate to show when configured. Applying the certificate, QuantumCloud™ Verify ensures the user of the social media account is indeed a verified and human user.

For example, with social media platform integration, the platform would call out to a QuantumCloud™ Verify REST endpoint supplying the username of the social media platform user, and the platform auth token obtained during onboarding. A result will be returned with the verification status of a user. Without social media platform integration, the verification may be accomplished by the user posting a short-URL link in their social media profile/bio, which, when clicked, will dynamically generate an HTML certificate. QuantumCloud™ Verify, in effect, enables the selective display of user information based on user preference and system constraints. For example, the user may use QuantumCloud™ Verify to select a subset of attributes from the set of attributes stored on the quantum cloud server; configure the user's account on the social media platform based on the subset of attributes; and display the selected subset of attributes on the user account according to the configuration.

Further, QuantumCloud™ Verify may adapt a part of one or more attributes from the subset of attributes when configuring the social media platform; and displaying said one or more attributes based on said adaptation. Adapting a part of one or more attributes may include masking the part of said one or more attributes and/or modifying said one or more attributes, so that said one or more attributes are semantically obscured. QuantumCloud™ Verify provides detailed instructions on how and what information may be displayed on the social media platform.

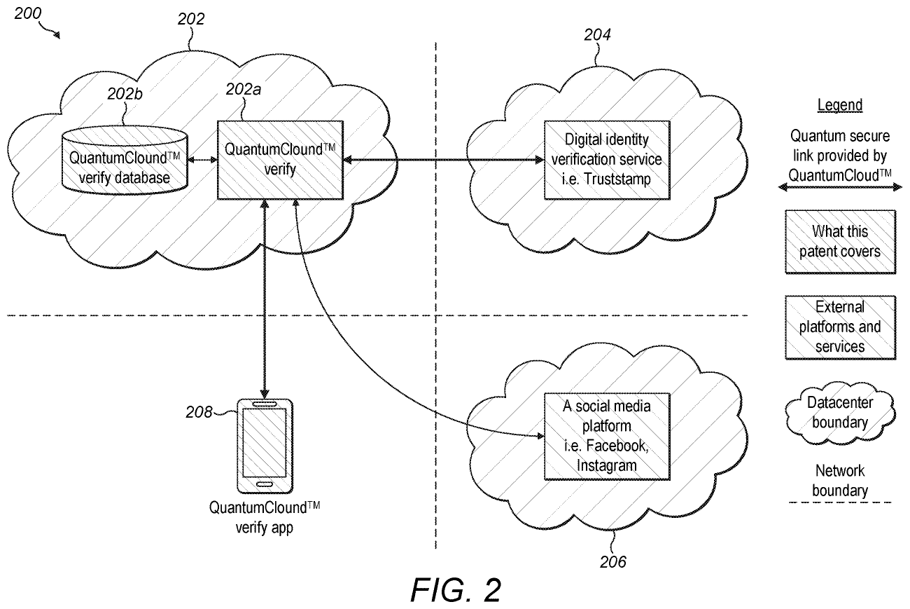

FIG. 2 is a schematic diagram 200 illustrating an example of a digital identity verification system. The figure presents a high-level diagram showing where QuantumCloud™ Verify 202/202a would sit within an exemplary architecture with respect to the cloud servers/database 202b. The QuantumCloud™ Verify 202a serves as a conduit for connecting the cloud servers 202b to the QuantumCloud™ Verify smartphone application(s) 208 in relation to external services and platforms.

The QuantumCloud™ Verify 202/202a may use a digital identity verification system 204 situated on at least one cloud server 202b. The system further comprises a database also situated on said least one cloud server secured via a quantum-secure link to one or more external user devices installed with QuantumCloud™ Verify smartphone applications 208. The cloud server is adapted to synchronize input from a user device with one or more social media platforms 206.

In particular, the cloud server 202b comprises one or more modules configured to perform a series of tasks of the system. These tasks include receiving a set of attributes associated with a user using the user device, where set of attributes is provided using a digital identity verification service 204; securing the set of attributes via the quantum-secure link connected to a database configured to store a timestamp associated with set of attributes as a record on said at least one cloud server, where the set of attributes are stored on the digital identity verification service 204; providing a first verification of the user identity on said at least one cloud server based on the set of attributes; selecting a social media platform from said one or more social media platforms via the user device; confirm whether the social media platform has been registered to said least one cloud server; connecting to the social media platform; retrieving user information and associated attributes from the social media platform; obtaining a secured token based on the user information and associated attributes; providing a second verification of the user based on the first verification and the secured token; and syncing the input from the user devices with one or more social media platforms 206 based on the first and second verifications.

Further, the system may be configured to select one or more verified attributes for use within said one or more social media platforms 206. The system may also be configured to generate certificates dynamically, based on user input, and stored on said at least one cloud server. These certificates may be viewable externally to the system in relation to said one or more verified attributes. The certificates may comprise the user information and associated attributes.

The system may be adapted to establish a quantum-secure link to a user account on the social media account and update the attributes in these accounts. The system selects the social media platform from a list of verified social media platforms 206 registered on user instruction. The instruction comprises user information for selecting a user account on the selected social media platform. The system provides a secured connection to the user account on the selected social media platform based on the second verification and transmits one or more attributes associated with the user account from the set of attributes to the social media platform via the secured connection. The user account is updated on the social media platform based on said one or more attributes transmitted via the secured connection.

The system may also selectively display user information on the social media platform based on user instruction. The system does so by selecting a subset of attributes from the set of attributes stored on QuantumCloud™ Verify. The selection is based on the user instruction, or proposed by the system. The system is adapted to configure a user account on the social media platform based on the subset of attributes and display the selected subset of attributes on the user account according to the configuration. The system adapts to a part of one or more attributes from the subset of attributes when configuring the social media platform, and displays said one or more attributes based on said adaptation. The part of one or more attributes from the subset of attributes may be adapted by masking the part of said one or more attributes and modifying said one or more attributes so that said one or more attributes are semantically obscured.

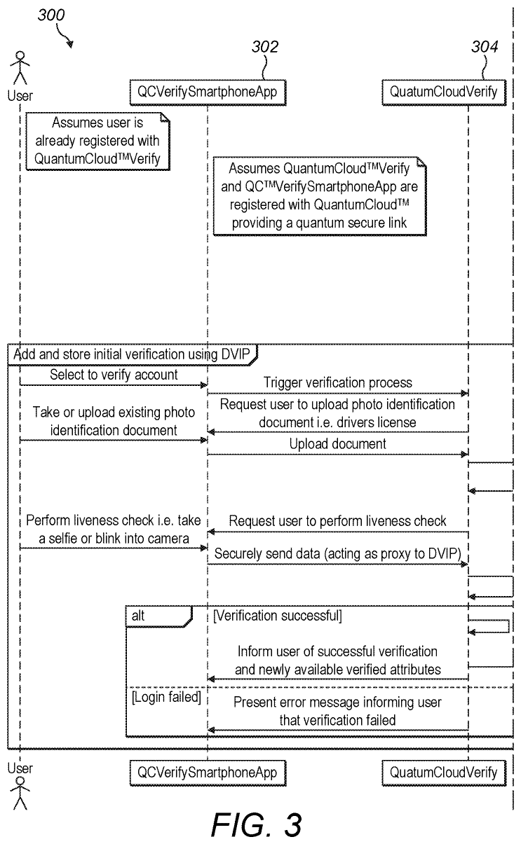

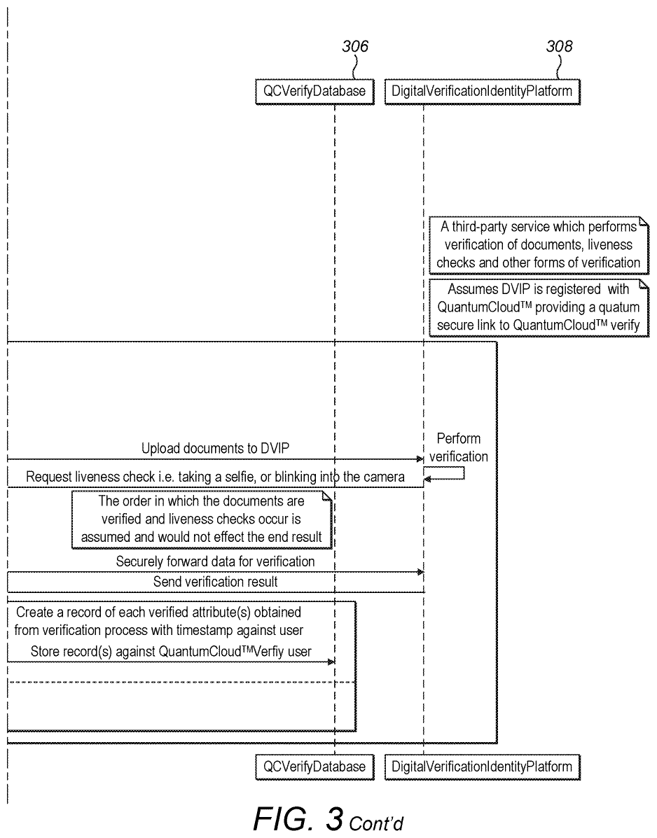

FIG. 3 is a diagram 300 illustrating an example of a user using a digital identity verification platform. More specifically, the figure shows the flow of how a newly registered QuantumCloud™ Verify 304 user would verify their identity in order to add verified attributes to their account.

A quantum-secure connection can be established by QuantumCloud™ Verify 304 based on a user instruction sent from the QuantumCloud™ Verify Smartphone application 302, provided that the QuantumCloud™ Verify application and DIVS 308 are registered with QuantumCloud™. Through the quantum-secure connection, a set of attributes associated with the user may be transmitted and processed via the DIVS 308 without having to be stored by QuantumCloud™ Verify 304 in its database 306.

For example, the user opens the QuantumCloud™ Verify smartphone application 302 and selects to “Verify” their profile. (This assumes this is the first time the User is verifying themselves using QuantumCloud™ Verify 304.) QuantumCloud™ Verify smartphone application 302 may send a request over the public internet/network to the QuantumCloud™ Verify cloud application. As QuantumCloud™ Verify smartphone application 302 and QuantumCloud™ Verify cloud application are both registered with QuantumCloud™, they can pre-negotiate a shared symmetric key allowing for the quantum-secure connection.

Upon establishing the connection, the QuantumCloud™ Verify cloud application 304 responds back to the QuantumCloud™ Verify smartphone application 302 and requests a set of user attributes, such as asking the user to upload a photo identification document. User takes a photo (or selects a pre-existing image) of a photo to identify the document (typically a driver's license or passport) to upload to QuantumCloud™ Verify cloud application 304. Without storing any photos, QuantumCloud™ Verify 304 transmits and uploads the document to the DIVS 308. (Here, the internal workflow of the DIVS 308 is assumed). The DIVS 308 performs verification on the photo identification document and requests a liveness check from the user. QuantumCloud™ Verify 304, acting as a proxy for the DIVS 308, sends a request to the QuantumCloud™ Verify Smartphone application for the user to perform a liveness check. User performs the liveness check, and the QuantumCloud™ Verify smartphone application 302 forwards the data onto the DIVS 308 over a quantum-secure connection. The DIVS 308 sends back the verification result to QuantumCloud™ Verify cloud application 304. If the result was successful, a record is added with a timestamp the verification took place and is persistently stored against the QuantumCloud™ Verify user, and a notification is sent back to inform the user verification was successful. If verification fails, no record is stored (within the QCVerify Database 306) against the QuantumCloud™ Verify 304 user and a notification is sent back to inform the user verification failed. Through this process, the set of attributes associated with the user becomes secured and retained via the quantum-secure link connected to QuantumCloud™ Verify 304. A first verification of the user on the quantum cloud server via QuantumCloud™ Verify 304 the based on the set of attributes is thereby complete.

FIG. 4 is a schematic diagram 400 illustrating an example of linking a social media account using QuantumCloud™ Verify smartphone application 402. The figure presents a flow of how a user links a social media account using the QuantumCloud™ Verify smartphone application 402.

In particular, the user may select a social media platform registered to the quantum cloud server with the QuantumCloud™ Verify smartphone application 402. This establishes a connection to the social media platform, optionally through an endpoint on the QuantumCloud™ Verify cloud application 404 requesting a list of registered social media platforms. The endpoint would be established in relation to the social media platform and configured to process one or more actions associated with the social media platform for verification of a user account. The connection via the endpoint enables the receipt of at least one part of the user information from the social media platform via the endpoint. QuantumCloud™ Verify may be used to obtain the authentication token from the social media platform via the endpoint. The established connection enables the user or the QuantumCloud™ Verify to retrieve user information and associated attributes from the social media platform. The connection would be a quantum-secure link.

Further, QuantumCloud™ Verify 404 would be provided with a secured token based on the user information and associated attributes in accordance with the respective quantum-secure symmetric signing key generated and known only to QuantumCloud™ Verify cloud application 404. To obtain the secured token, QuantumCloud™ Verify 404 requests the authentication token from the social media platform 408, where the authentication token comprises at least one user identifier associated with a user account on the social media platform 408. The authentication token is used to determine the registration of the social media platform 408. Based on the identifier associated with a user account from the authentication token, a search for the user account on the social media platform 408 is conducted in relation to the authentication token and the registration. A secured token unique to each account is requested based on the search and applied in relation to the second verification. The secured token comprises the user information and associated attributes, which enables the second verification.

To deploy QuantumCloud™ Verify 404, it is assumed that the user is registered with QuantumCloud™ Verify 404 and has verified attributes. QuantumCloud™ Verify smartphone application 402 and QuantumCloud™ Verify cloud application 404 are already registered with QuantumCloud™ allowing a quantum-secure connection such that the QuantumCloud™ Verify cloud application 404 has a quantum-secure symmetric signing key generated and known only to QuantumCloud™ Verify cloud application 404. In addition, the user has their own quantum-secure symmetric key used to encrypt/decrypt their data at rest. Finally, social media platform(s) 408 is registered with QuantumCloud™ Verify 404 as a verifier. Based on these assumptions, the following is an example of the steps for the verification starting from the action of a user.

In the example, the user launches the QuantumCloud™ Verify smartphone application 402 and selects to link a social media account. QuantumCloud™ Verify smartphone application 402 calls a REST endpoint on the QuantumCloud™ Verify cloud application requesting a list of registered social media platforms 408, which are retrieved from persistent storage (QuantumCloud™ Verify database 406). QuantumCloud™ Verify cloud application returns the list of registered social media platforms 408 to the QuantumCloud™ Verify smartphone application 402 and presents the list to the user. User selects a social media platform 408 from the list and is asked to log into the social media platform 408. The log in request is sent from the QuantumCloud™ Verify smartphone application 402 to the social media platform 408 and a login result is returned to the QuantumCloud™ Verify smartphone application 402. On successful login to the social media platform 408, QuantumCloud™ Verify smartphone application 402 presents a list of attributes the user has previously verified, as described herein. User selects which attributes they would like to share with the social media platform 408. QuantumCloud™ Verify smartphone application 402 securely sends the user's social media platform username, the social media platform name, and the selected verified attributes to the QuantumCloud™ Verify cloud application 404. QuantumCloud™ Verify cloud application 404 creates a secured token which encapsulates the user's social media platform username, the social media platform name and the selected verified attributes and signs this with the QuantumCloud™ Verify Cloud application 404 signing key. QuantumCloud™ Verify cloud application 404 encrypts the signed token using the user's user key and persistently stores this in a record in the QuantumCloud™ Verify database 406. QuantumCloud™ Verify cloud application also stores the user's social media platform username with the name of the social media platform. This allows for fast lookups. On unsuccessful login, QuantumCloud™ Verify cloud application 404 sends a response to QuantumCloud™ Verify smartphone application 402 to inform the user that login failed to the social media platform 408.

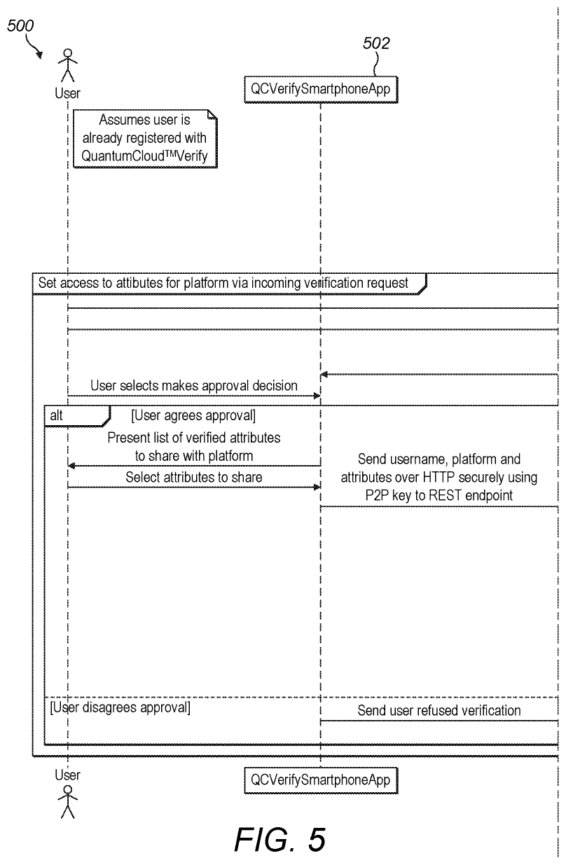

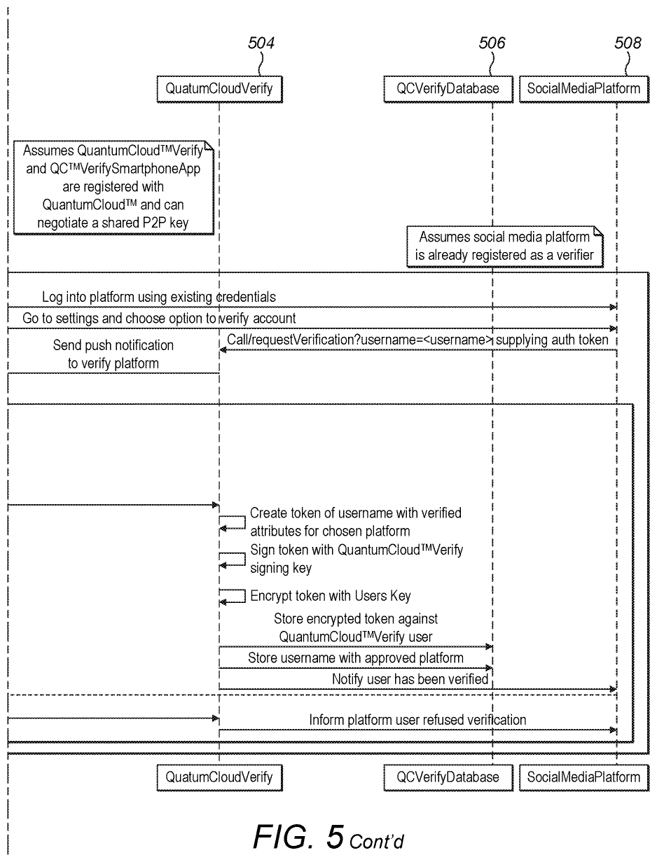

FIG. 5 is a diagram 500 illustrating an example of linking a social media account from the social media platforms settings. The figure shows how verification could be triggered from the settings of the social media platform 508.

The triggering from the settings of the social media platform 508 starts with a user logging onto the social media platform using their credentials. The user may select/click on the settings page of the social media platform and clicks “Verify account”. In response, the social media platform calls the QuantumCloud™ Verify cloud application 504, passing its authentication token to prove it is a legitimate request coming from a registered social media platform 508, to request verification from the user. QuantumCloud™ Verify cloud application 504 sends a push notification to the QuantumCloud™ Verify smartphone application 502.

Based on the push notification, the user is presented with the option to agree or disagree approval. If the user agrees, the user will select which attributes he/she would like to share with the social media platform. QuantumCloud™ Verify smartphone application 502 securely sends the user's social media platform username, the social media platform name and the selected verified attributes to the QuantumCloud™ Verify cloud application 504. QuantumCloud™ Verify cloud application 504 creates a token which encapsulates the user's social media platform username, the social media platform name and the selected verified attributes and signs this with the QuantumCloud™ Verify cloud application signing key. QuantumCloud™ Verify cloud application encrypts the signed token using the user's user key and persistently stores (via the database 506) this in a record in the QuantumCloud™ Verify database 506. QuantumCloud™ Verify cloud application 504 also stores (via the database 506) the user's social media platform username with the name of the social media platform. This allows for fast lookups. QuantumCloud™ Verify cloud application 504 notifies the social media platform 508 (presumably via a REST endpoint) that the user is now verified. If user disagrees approval, QuantumCloud™ Verify smartphone application 502 sends a response to QuantumCloud™ Verify cloud application 504, which in turn notifies the social media platform 508 (presumably via a REST endpoint) that the user refused verification.

FIG. 6 is a diagram 600 illustrating another example of generating a certificate to show verified attributes for social media platforms. In particular, the figure shows how a user could generate a certificate-like HTML page. The HTML page shows the user's social media username along with the verified attributes they chose to share. The workflow shown in the figure sets up the certificate by providing the user with a short-URL they can place anywhere, and what attributes they would like the certificate to show when this link is clicked. It is understood that the user in this case has already registered with QuantumCloud™ Verify 604 and has verified attributes according to steps described herein.

Prior to generating the certificate, a quantum-secure connection would have been established, linking the social media account to the QuantumCloud™ Verify 604. The social media platform(s) 608a/608b would have been registered with QuantumCloud™ Verify 604 as a verifier and has an authentication token. The token may be generated based on the user identifier comprising the user information and associated attributes. The token may be signed using a signing key unique to the quantum cloud (provided by QuantumCloud™) and encrypted using a user key. The secured token may be stored (via the database 606) in relation to the user information and associated attributes.

On the QuantumCloud™ Verify smartphone application 602, the user may select the social media platform from a list of verified social media platform(s) 608a/608b registered to the QuantumCloud™ Verify 604 through QuantumCloud™. QuantumCloud™ Verify 604 may help identify a user account on the selected social media platform based on the user information. The generated certificate provides added security for the user account on the selected social media platform based on a verification process using the certificate. The attributes associated with the user account may be transmitted to the social media platform via the secured connection in order to update the user account.

To generate the certificate, for example, user may click on “Generate a verification certificate” in the QuantumCloud™ Verify smartphone application 602. QuantumCloud™ Verify smartphone application 602 calls out to QuantumCloud™ Verify cloud application 604 and returns a list of previously linked social media platform(s) 608a/608b. User may select a previously linked social media platform to generate a certificate. QuantumCloud™ Verify smartphone application 602 calls out to QuantumCloud™ Verify cloud application 604 and returns a list of previously verified attributes to the user. User may select what previously verified attributes he/she wants to be shown in the generated certificate. QuantumCloud™ Verify smartphone application 602 quantum-securely sends selected attributes to QuantumCloud™ Verify cloud application 604. QuantumCloud™ Verify cloud application 604 generates a short-URL of where the certificate will be dynamically generated too. It is to be noted the certificate is not generated until a user clicks on the short-URL link. QuantumCloud™ Verify cloud application 604 returns the short-URL to the QuantumCloud™ Verify smartphone application 602. User may copy this link and places it in their profile/bio of the social media platform they selected for this certificate. A separate certificate would be generated for each social media platform.

FIG. 7 is a diagram 700 illustrating an example of verifying a social media account is a verified user. The figure shows how social media platforms 708 would integrate with QuantumCloud™ Verify 704.

For integration from the social media platform 708 to prove an account is verified, starting with the social media platform 708, a call is made to the QuantumCloud™ Verify cloud application 704, passing its authentication token to prove it's a legitimate request coming from a registered social media platform 708, to attempt to verify a user. QuantumCloud™ Verify cloud application 704 authenticates the social media platform 708. QuantumCloud™ Verify cloud application 704 searches for the username of the user to be verified against the social media platform 708, which would have been persistently stored in the QuantumCloud™ Verify database 706 during verification for fast lookups. If a record is found, QuantumCloud™ Verify cloud application 704 requests the token associated with this record. QuantumCloud™ Verify cloud application 704 decrypts the token using the user's User Key. The signature of the token is verified using the QuantumCloud™ Verify cloud application signing key. The verified attributes are then returned to the social media platform 708 to be displayed by the social media platform. If a record is not found, QuantumCloud™ Verify cloud application 704 returns a message to the social media platform 708 to say this user has no verification data.

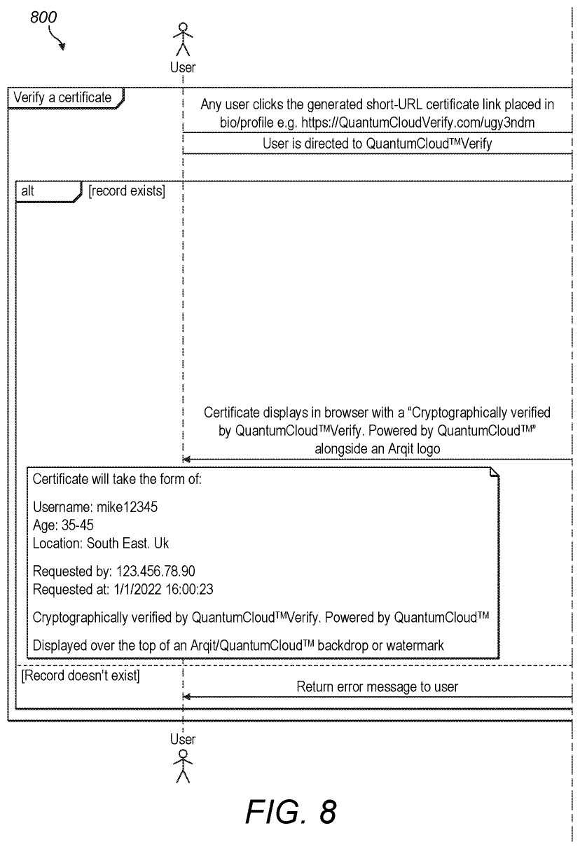

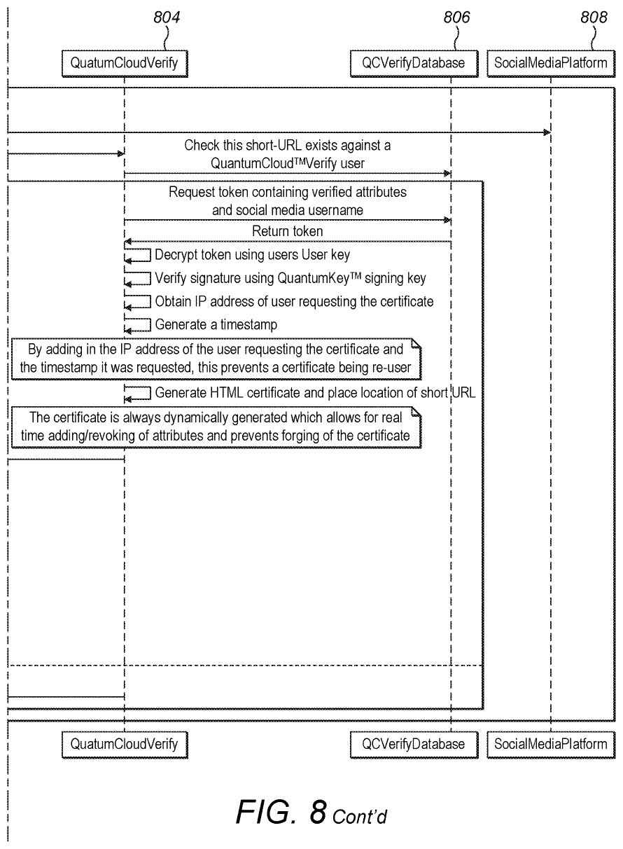

FIG. 8 is a diagram 800 illustrating an example of Verifying a public-facing QuantumCloud™ Verify certificate via a URL. The figure shows when a user generated short-URL is clicked, and how the certificate is dynamically generated. The certificate should show the username of the social media account is being verified and will display additional information such as the IP address of the user who clicked the link and a timestamp of when it was clicked. Along with the verified attributes, a user has chosen to share, if any.

Showing the social media account username being verified as part of the certificate prevents someone from copying and pasting someone else's short-URL and passing it off as their own. By also displaying the IP address of the user requesting to see the certificate and a timestamp, this shows the certificate was dynamically generated at the point it was requested. It is understood that the certificate associated has been generated and copied the resulting short-URL into their social media accounts profile/bio.

For verifying a public-facing QuantumCloud™ Verify certificate via a URL, starting with the user, the user may click on the short-URL certificate link placed in the user's profile/bio. This user is thereby directed to the QuantumCloud™ Verify cloud application 804. QuantumCloud™ Verify cloud application 804 looks up in the QuantumCloud™ Verify database 806 that the user whose certificate is being requested has this short-URL linked against them. If a record is found, QuantumCloud™ Verify cloud application 804 requests the token associated with this record. QuantumCloud™ Verify cloud application 804 decrypts the token using the user's User Key.

The signature of the token is verified using the QuantumCloud™ Verify cloud application signing key. QuantumCloud™ Verify cloud application 804 obtains the IP address of the user requesting the certificate. This proves the certificate was generated dynamically and prevents it from ever being re-used. QuantumCloud™ Verify cloud application 804 generates a timestamp in the form of dd/mm/yyyy HH:MM:SS. QuantumCloud™ Verify 804 generates a HTML certificate showing the username of the user whose certificate is being requested, the users verified attributes and places it at the location of the pre-generated short-URL. If a user changes what attributes to show, these will be reflected when the short-URL is clicked next as the certificate is dynamically generated. The certificate displays in a browser with an “Arqit” watermark. If the short-URL doesn't exist for this user than an error page is displayed to the user requesting the certificate instead.

FIG. 9A is a diagram 900A illustrating an example of an end-to-end workflow of QuantumCloud™ starting from a user. The interactions of a user with QuantumCloud™ Verify are shown from the point of onboarding to finally sharing the link of a generated certificate.

It is understood that the identity of the user is never known or stored in a way that QuantumCloud™ Verify can access without further users'permission, as all user data is encrypted with an individual user key (provided by QuantumCloud™). Moreover, all data-at-rest and data-in-transit are protected with a quantum-safe encryption key (provided by QuantumCloud™ and described herein). User may select which attributes are displayed on the dynamically generated certificate, including the ability to limit the specificity of the information. User may also remove/revoke access from social media accounts at any time. Once user verifies themselves, the user may reuse this verification across all social media platforms. The above is achieved through QuantumCloud™ Verify and associated components described herein.

FIG. 9B is a diagram 900B illustrating an example of an end-to-end workflow of QuantumCloud™ without a cloud application proxy. In particular, the figure shows a slightly modified workflow with the interactions of a user ™Verify from the point of onboarding to finally sharing the link of a generated certificate, but with direct communication from the smartphone application to the DIVS.

In respect of FIG. 9A, it is understood that the system in the figure would not have access to any of the users'sensitive documents as these bypasses the QuantumCloud™ Verify system. The user interacts directly with the DIVS.

FIG. 10 is a diagram 1000 illustrating an example of an onboarding process with QuantumCloud™ Verify, where a social media platform would be onboarded with QuantumCloud™ Verify. In the process, all data-at-rest and data-in-transit in relation to QuantumCloud™ Verify are protected with a quantum-safe encryption key. User data could only decrypt with the user key, which users can revoke at will/anytime. A user may also decide that the social media platform has no access to their identity information, therefore, only receives notification that they have successfully verified their identity. The system may provide the social media platforms with a way to filter unverified users in their UI, with minimal software changes required by their engineers.

FIG. 11 is a diagram 1100 illustrating an example of linking QuantumCloud™ Verify with a social media platform, showing how QuantumCloud™ Verify and a social media platform use QuantumCloud™ to negotiate a shared peer-to-peer (P2P) key to create a quantum-secure link. Here, the social media platform registering and provisioning with QuantumCloud™ to allow them to broker quantum-safe encrypted keys for secure communications and storage.

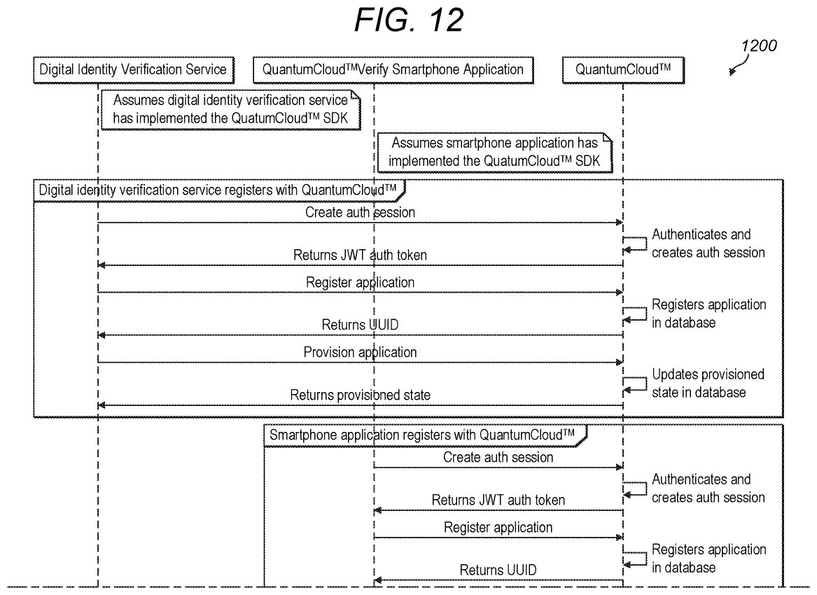

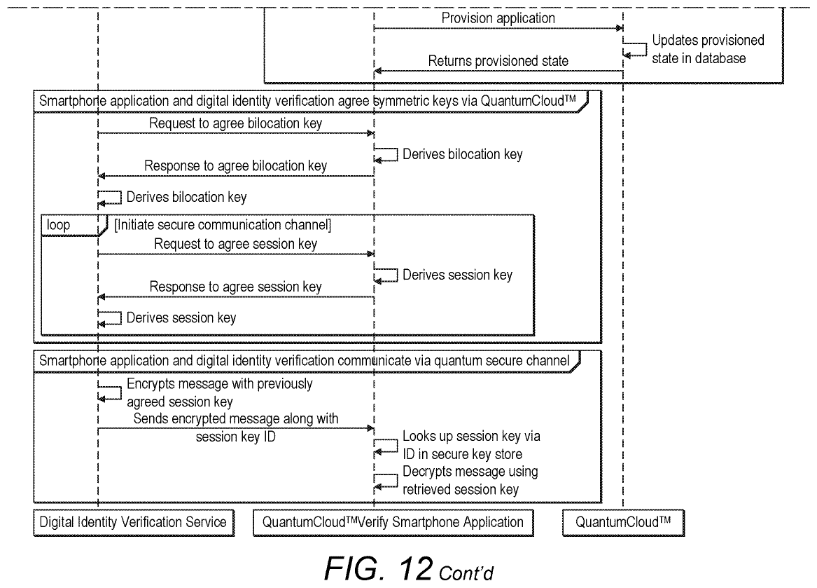

FIG. 12 is a diagram 1200 illustrating an example of generating a quantum-secure link between QuantumCloud™ Verify cloud application and QuantumCloud™ Verify smartphone application, where QuantumCloud™ Verify cloud and a DIVS use QuantumCloud™ to negotiate a shared P2P key to create a quantum-secure link. Here, DIVS registering and provisioning QuantumCloud™ to allow them to broker quantum-safe encrypted keys for secure communications.

FIG. 13 is a diagram 1300 illustrating an example of generating a quantum-secure link between QuantumCloud™ Verify cloud application and QuantumCloud™ Verify smartphone application, where the QuantumCloud™ Verify cloud and smartphone applications use QuantumCloud™ to negotiate a shared P2P key to create a quantum-secure link. Here, QuantumCloud™ Verify smartphone application registering and provisioning with QuantumCloud™ to allow them to broker quantum-safe encrypted keys for secure communications.

FIG. 14 is a block diagram of a computer or computing device that may be used to implement one or more aspects of the QuantumCloud™ Verify system(s), apparatus, method(s), and/or process(es) combinations thereof, modifications thereof, and/or as described with reference to FIGS. 1 to 13 and/or as described herein. Computing apparatus/system 1400 includes one or more processor unit(s) 1402, an input/output unit 1404, communications unit/interface 1406, a memory unit 1408 in which the one or more processor unit(s) 1402 are connected to the input/output unit 1404, communications unit/interface 1406, and the memory unit 1408. In some embodiments, the computing apparatus/system 1400 may be a server, or one or more servers networked together. In some embodiments, the computing apparatus/system 1400 may be a computer or supercomputer/processing facility or hardware/software suitable for processing or performing one or more aspects of the QuantumCloud™ Verify system(s), apparatus, method(s), and/or process(es) combinations thereof, modifications thereof, and/or as described with reference to FIGS. 1 to 13 and/or as described herein. The communications interface 1406 may connect the computing apparatus/system 1400, via a communication network, with one or more services, devices, server system(s), cloud-based platforms, systems for implementing subject-matter databases and/or knowledge graphs for implementing the invention as described herein. The memory unit 1408 may store one or more program instructions, code or components such as, by way of example only but not limited to, an operating system and/or code/component(s) associated with the process(es)/method(s) as described with reference to FIGS. 1 to 13, additional data, applications, application firmware/software and/or further program instructions, code and/or components associated with implementing the functionality and/or one or more function(s) or functionality associated with one or more of the method(s) and/or process(es) of the device, service and/or server(s) hosting the QuantumCloud™ Verify process(es)/method(s)/system(s), apparatus, mechanisms and/or system(s)/platforms/architectures for implementing the invention as described herein, combinations thereof, modifications thereof, and/or as described with reference to at least one of the FIGS. 1 to 13.

In one aspect is a method of using a quantum-secure link to validate user identity on one or more social media platforms, the method comprising: receiving a set of attributes associated with a user, wherein said one or more attributes are provided using a digital identity verification service; securing the set of attributes via the quantum-secure link connected to a quantum cloud service; storing a timestamp of the set of attributes as a record on the quantum cloud via the quantum link; providing a first verification of the user on the quantum cloud based on the set of attributes in relation to the record; selecting a social media platform registered to the quantum cloud; establishing a connection to the social media platform; retrieving user information and associated attributes from the social media platform using the connection; obtaining a secured token based on the user information and associated attributes; and providing a second verification of the user identity based on the first verification and the secured token, wherein the second verification is dependent on the first verification.

In another aspect is a digital identity verification system, the system comprising: at least one cloud server, a database situated on said least one cloud server secured via a quantum-secure link to one or more external user devices, wherein said least one cloud server is adapted to sync input from a user device with one or more social media platforms, wherein said at least one cloud server comprises one or more modules configured to: receive a set of attributes associated with a user using the user device, wherein said one or more attributes are provided using a digital identity verification service; secure the set of attributes via the quantum-secure link connected to a database configured to store a timestamp of the set of attributes as a record on said at least one cloud server; provide a first verification of the user identity on said at least one cloud server based on the set of attributes in relation to the record; select a social media platform from said one or more social media platforms via the user device; confirm whether the social media platform has been registered to said least one cloud server; connect to the social media platform; retrieve user information and associated attributes from the social media platform; obtain a secured token based on the user information and associated attributes; provide a second verification of the user based on the first verification and the secured token; and syncing the input from the user devices with one or more social media platforms based on the first verification and second verification.

In another aspect is a computer-readable medium comprising computer-readable code or instructions stored thereon, which when executed on a processor, causes the processor to implement the method according to any of one or more previous aspects or below options.

In another aspect is an apparatus comprising a processor, a memory and a communication interface, the processor connected to the memory and communication interface, wherein the apparatus is adapted or configured to implement the method according to any of one or more previous aspects or below options.

The following options may be combined with any one or more of the above aspects as understood by the skilled person.

As an option, validating the user identity on said one or more social media platforms based on the first verification and the second verification.

As an option, further comprising: controlling user settings with respect to said one or more social media platforms once the user is validated.

As an option, further comprising: registering a social media platform to the quantum cloud; verifying the social media platform; and establishing a secured connection to the social media platform via the secured token generated by the quantum cloud service or QuantumCloud™.

As an option, further comprising: selecting the social media platform from a list of verified social media platforms registered to the quantum cloud server; identifying a user account on the selected social media platform based on the user information; and providing a secured connection to the user account on the selected social media platform based on the second verification, wherein the secured connection is the quantum-secure link.

As an option, further comprising: transmitting one or more attributes associated with the user account from the set of attributes to the social media platform via the secured connection; and updating the user account based on said one or more attributes transmitted.

As an option, wherein obtaining a secured token based on the user information and associated attributes, further comprising: receiving a user identifier associated with a user account on the social media platform; generating a token based on the user identifier comprising the user information and associated attributes; signing the token using a signing key unique to the quantum cloud; and encrypting the token using a user key; and providing the secured token encrypted for the second verification.

As an option, wherein the secured token is stored in relation to the user information and associated attributes.

As an option, further comprising: requesting an authentication token from the social media platform, wherein the authentication token comprises at least one user identifier associated with a user account on the social media platform; determining registration of the social media platform based on the authentication token; conducting a search for the user account on the social media platform in accordance with the registration based on said at least one user identifier; requesting the secured token based on the search, wherein the secured token comprises the user information and associated attributes; and applying the secured token in relation to the second verification.

As an option, further comprising: decrypting the secured token using a user key; verifying the user information using a signing key; and identifying a subset of attributes corresponding to the user information and the associated attributes.

As an option, further comprising: transmitting a subset of attributes from the set of attributes to the social media platform, wherein the subset of attributes are stored on the quantum cloud in relation to the secured token; and updating the subset of attributes on the social media platform.

As an option, further comprising: selecting a subset of attributes from the set of attributes stored on the quantum cloud; configuring a user account on the social media platform based on the subset of attributes; and displaying the selected subset of attributes on the user account according to the configuration.

As an option, further comprising: adapting a part of one or more attributes from the subset of attributes when configuring the social media platform; and displaying said one or more attributes based on said adaptation.

As an option, wherein adapting a part of one or more attributes, further comprising: masking the part of said one or more attributes; and/or modifying said one or more attributes, so that said one or more attributes are semantically obscured.

As an option, further comprising: establishing an endpoint in relation to the social media platform, wherein the endpoint is configured to process one or more actions associated with the social media platform for verification of a user account; receiving at least one part of the user information from the social media platform via the endpoint; and obtaining the authentication token from the social media platform.

As an option, further comprising: generating one or more certificates based on whether the first verification and the second verification are successful; and selecting a subset of attributes from the set of attributes; and displaying the subset of attributes based on said one or more certificates.

As an option, wherein the system is configured to select one or more verified attributes for use within said one or more social media platforms.

As an option, wherein the system is configured to generate one or more certificates dynamically based on user input and store said one or more certificates on said at least one cloud server.

As an option, wherein the certificates are viewable externally to the system in relation to said one or more verified attributes.

As an option, wherein said one or more certificates comprise the user information and associated attributes.

As an option, wherein said one or more certificates display the user information and associated attributes in accordance with a timestamp.

As an option, wherein the database is configured to store user information and associated attributes.

As an option, wherein the user information and associated attributes are stored in relation to the secured token and/or said one or more certificates.

In the embodiments, examples, and aspects of the invention as described above such as process(es), method(s), and/or system(s) and/or components for transmitting data via the QuantumCloud™ Verify may be implemented on and/or comprise one or more cloud platforms, one or more server(s) or computing system(s) or device(s). A server may comprise a single server or network of servers, the cloud platform may include a plurality of servers or network of servers. In some examples the functionality of the server and/or cloud platform may be provided by a network of servers distributed across a geographical area, such as a worldwide distributed network of servers, and a user may be connected to an appropriate one of the network of servers based upon a user location and the like.

The above description discusses embodiments of the invention with reference to a single user for clarity. It will be understood that in practice the system may be shared by a plurality of users, and possibly by a very large number of users simultaneously.

The embodiments described above may be configured to be semi-automatic and/or are configured to be fully automatic. In some examples a user or operator of the querying system(s)/process(es)/method(s) may manually instruct some steps of the process(es)/method(es) to be carried out.

The described embodiments of the invention a system, process(es), method(s) and/or tool for querying a graph data structure and the like according to the invention and/or as herein described may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the process/method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium or non-transitory computer-readable medium. Computer-readable media may include, for example, computer-readable storage media. Computer-readable storage media may include volatile or non-volatile, removable or non-removable media implemented in any method or technology for storage of information such as computer-readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection or coupling, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, IoT devices, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary”, “example” or “embodiment” is intended to mean “serving as an illustration or example of something”. Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art.

What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-27. (canceled)

28. A computer-implemented method of using a quantum-secure link to validate user identity on one or more social media platforms, the method comprising:
receiving a set of attributes associated with a user, wherein said one or more attributes are provided using a digital identity verification service;
securing the set of attributes via the quantum-secure link connected to a quantum cloud service;
storing a timestamp of the set of attributes as a record on a quantum cloud via the quantum link;
providing a first verification of the user on the quantum cloud based on the set of attributes in relation to the record;
selecting a social media platform registered to the quantum cloud;
establishing a connection to the social media platform;
retrieving user information and associated attributes from the social media platform using the connection;
obtaining a secured token based on the user information and associated attributes; and
providing a second verification of the user identity based on the first verification and the secured token, wherein the second verification is dependent on the first verification.

29. The method of claim 28, further comprising:
validating the user identity on said one or more social media platforms based on the first verification and the second verification.

30. The method of claim 29, further comprising:
controlling user settings with respect to said one or more social media platforms once the user is validated.

31. The method of claim 28, further comprising:
registering a social media platform to the quantum cloud;
verifying the social media platform; and
establishing a secured connection to the social media platform via the secured token generated by quantum cloud service.

32. The method of claim 28, further comprising:
selecting the social media platform from a list of verified social media platforms registered to the quantum cloud;
identifying a user account on the selected social media platform based on the user information; and
providing a secured connection to the user account on the selected social media platform based on the second verification, wherein the secured connection is the quantum-secure link.

33. The method of claim 32, further comprising:
transmitting one or more attributes associated with the user account from the set of attributes to the social media platform via the secured connection; and
updating the user account based on said one or more attributes transmitted.

34. The method of claim 28, wherein obtaining a secured token based on the user information and associated attributes, further comprising:
receiving a user identifier associated with a user account on the social media platform;
generating a token based on the user identifier comprising the user information and associated attributes;
signing the token using a signing key unique to the quantum cloud; and
encrypting the token using a user key; and
providing the secured token encrypted for the second verification.

35. The method of claim 34, wherein the secured token is stored in relation to the user information and associated attributes.

36. The method of claim 28, further comprising:
requesting an authentication token from the social media platform, wherein the authentication token comprises at least one user identifier associated with a user account on the social media platform;
determining registration of the social media platform based on the authentication token; conducting a search for the user account on the social media platform in accordance with the registration based on said at least one user identifier;
requesting the secured token based on the search, wherein the secured token comprises the user information and associated attributes; and
applying the secured token in relation to the second verification.

37. The method of claim 36, further comprising:
decrypting the secured token using a user key;
verifying the user information using a signing key; and
identifying a subset of attributes corresponding to the user information and the associated attributes.

38. The method of claim 36, further comprising:
transmitting a subset of attributes from the set of attributes to the social media platform, wherein the subset of attributes is stored on the quantum cloud in relation to the secured token; and
updating the subset of attributes on the social media platform.

39. The method of claim 28, further comprising:
selecting a subset of attributes from the set of attributes stored on the quantum cloud; configuring a user account on the social media platform based on the subset of attributes; and displaying the selected subset of attributes on the user account according to the configuration.

40. The method of claim 39, further comprising:
adapting a part of one or more attributes from the subset of attributes when configuring the social media platform; and
displaying said one or more attributes based on said adaptation.

41. The method of claim 40, wherein adapting a part of one or more attributes, further comprising:
masking the part of said one or more attributes; and/or
modifying said one or more attributes, so that said one or more attributes are semantically obscured.

42. The method of claim 28, further comprising:
establishing an endpoint in relation to the social media platform, wherein the endpoint is configured to process one or more actions associated with the social media platform for verification of a user account;
receiving at least one part of the user information from the social media platform via the endpoint; and
obtaining the authentication token from the social media platform.

43. The method of claim 28, further comprising:
generating one or more certificates based on whether the first verification and the second verification are successful; and
selecting a subset of attributes from the set of attributes; and
displaying the subset of attributes based on said one or more certificates.

44. A digital identity verification system, the system comprising:
at least one cloud server, a database situated on said least one cloud server secured via a quantum-secure link to one or more external user devices, wherein said least one cloud server is adapted to sync input from a user device with one or more social media platforms, wherein said at least one cloud server comprises one or more modules configured to:
receive a set of attributes associated with a user using the user device, wherein said one or more attributes are provided using a digital identity verification service;
secure the set of attributes via the quantum-secure link connected to a database configured to store a timestamp of the set of attributes as a record on said at least one cloud server;
provide a first verification of the user identity on said at least one cloud server based on the set of attributes in relation to the record;
select a social media platform from said one or more social media platforms via the user device;
confirm whether the social media platform has been registered to said least one cloud server;
connect to the social media platform;
retrieve user information and associated attributes from the social media platform;
obtain a secured token based on the user information and associated attributes;
provide a second verification of the user based on the first verification and the secured token; and
sync the input from the user devices with one or more social media platforms based on the first verification and second verification.

45. The system of claim 44, wherein the system is configured to select one or more verified attributes for use within said one or more social media platforms.

46. The system of claim 44, wherein the system is configured to generate one or more certificates dynamically based on user input and store said one or more certificates on said at least one cloud server.

47. The system of claim 46, wherein the certificates are viewable externally to the system in relation to said one or more verified attributes.
